(19) United States
(12) Patent Application Publication
(10) Pub. No.: US 2026/0265122 A1
(43) Pub. Date: Sep. 10, 2026

(54) GLASS-BASED SUBSTRATE AND METHODS OF MAKING THE SAME

(71) Applicant: CORNING INCORPORATED, CORNING, NY (US)

(72) Inventors: Joy Banerjee, Corning, NY (US); Albert Joseph Fahey, Corning, NY (US); Aize Li, Painted Post, NY (US); Cheol Hwi Lim, Hanoi (VN); Yu-Jiung Lin, New Taipei City (TW); Christine Marie Mahoney Fahey, Corning, NY (US); James Joseph Price, Corning, NY (US); Vitor Marino Schneider, Painted Post, NY (US)

(21) Appl. No.: 19/178,239

(22) Filed: Apr. 14, 2025

Related U.S. Application Data
(60) Provisional application No. 63/634,087, filed on Apr. 15, 2024.
(60) Provisional application No. 63/637,016, filed on Apr. 22, 2024.

(51) Int. Cl. C03C 15/00; C03C 3/06

(52) U.S. Cl. CPC C03C 15/00; C03C 3/06

(57) ABSTRACT

Glass-based substrates have a substrate thickness from 20 micrometers to 200 micrometers and a depletion layer extending from a first major surface to a first depth from 1 nanometers to 75 nanometers. The depletion layer is depleted in one or more alkali metal oxide, alkaline earth metal oxide, alumina, or combinations thereof relative to a bulk. The depletion layer is enriched in silica relative to the bulk.

### CROSS-REFERENCE TO RELATED APPLICATIONS

This application claims the benefit of priority under of U.S. Provisional Application Ser. No. 63/637,016, filed on Apr. 22, 2024, and U.S. Provisional Application Ser. No. 63/634,087, filed on Apr. 15, 2024, the contents of each of which is relied upon and incorporated herein by reference in its entirety.

### FIELD

The present disclosure relates generally to glass-based substrates and methods of making the same and, more particularly, to glass-based substrates having a depletion layer and methods of making the same.

### BACKGROUND

Glass-based substrates are commonly used, for example, in display devices, e.g., liquid crystal displays (LCDs), electrophoretic displays (EPD), organic light-emitting diode displays (OLEDs), plasma display panels (PDPs), or the like.

There is a desire to develop glass-based substrates with reduced thickness for consumer electronic devices that can provide good scratch resistance. When the glass-based substrate is to be mounted over a display device, it is desired that the glass-based substrate not distort or impair viewing of the display device. Alternatives, including plastic displays and covers tend to have poor impact resistance and/or puncture resistance. Also, plastic displays and covers can be easily scratched. It has been discovered that even glass-based substrate can be subject to scratching by small loads that may occur incidentally during processing and/or transport. Further, these scratches can reduce yield and/or impair an appearance of the glass-based substrate, and can even be seen by the naked eye in some circumstances. Consequently, there is a need to develop glass-based substrates with improved resistance to small loads and/or with reduced visibility of small scratches.

### SUMMARY

There are set forth herein glass-based substrates and methods of making the same having a depletion layer extending from the first major surface. Providing a depletion layer can provide enhanced micro-scale scratch resistance to the glass-based substrate. As demonstrated by the Examples below, it appears that the depletion layer reduces the scratch depth for milliNewton scale loads (e.g., 0.5 mN, 1 mN) that can occur incidentally as glass-based substrates are transported, packaged, or otherwise handled during processing and/or shipping. When the scratch depth is less than or equal to the depth of depletion region (or even within a factor of 2), the scratch may be inhibited (e.g., prevented) from further growth (e.g., propagation) due to the different properties of the depletion layer relative to the bulk of the glass-based substrate. Additionally or alternatively, scratches within the depletion layer may not be visible to the naked eye, which can improve an aesthetic (e.g., cosmetic) appearance of the glass-based substrate relative to glass-based substrate experiencing the same loads (e.g., scratching conditions) without the presence of a depletion layer. However, depletion layers thicker than 75 nm can be visible to the naked eye when viewing an image through the glass-based substrate, which can impair a functionality of the glass-based substrate in display-related applications. Also, scratches in such thicker depletion layers (e.g., greater than 75 nm, 100 nm or more) can be visible (even when the scratch depth is within the depletion layer but deeper than about 30 nm or more (e.g., 50 nm or more), which can be impair an appearance of the glass-based substrate.

The depletion layer of the present disclosure can be formed by various methods. Examples 3 and 5 were produced using a dilute treatment solution following etching. It is unexpected that a dilute treatment solution (e.g., alkaline detergent in a concentration of 1.0 wt % or less, 0.9 wt % or less, 0.8 wt % or less, 0.7 wt % or less, etc.) following an etching treatment can be used to form a depletion region (e.g., providing improved micro-scratch resistance as discussed herein).

Some example aspects of the disclosure are described below with the understanding that any of the features of the various aspects may be used alone or in combination with one another.

Aspect 1. A glass-based substrate comprising:
a first major surface and a second major surface opposite the first major surface, a substrate thickness defined between the first major surface and the second major surface, and the substrate thickness is from 20 micrometers to 200 micrometers; and
a depletion layer extending from the first major surface to a first depth from the first major surface, the depletion layer is depleted in one or more alkali metal oxide, alkaline earth metal oxide, alumina, or combinations thereof relative to a bulk of the glass-based substrate, the depletion layer is enriched in silica relative to the bulk, and the first depth is from 1 nanometer to 75 nanometers.

Aspect 2. The glass-based substrate of aspect 1, wherein the depletion layer exhibits a first local peak in an infrared reflectance spectrum, the bulk exhibits a second local peak in an infrared reflectance spectrum, a location of the first local peak and a location of the second local peak are from 1000 cm⁻¹ to 1070 cm⁻¹, and a difference of the location of the second local peak minus the location of the first local peak is greater than or equal to 0.4 cm⁻¹.

Aspect 3. The glass-based substrate of aspect 2, wherein the difference of the location of the second local peak minus the location of the first local peak is from greater than or equal to 0.5 cm⁻¹ to less than or equal to 5.0 cm⁻¹.

Aspect 4. The glass-based substrate of any one of aspects 2-3, wherein the difference of the location of the second local peak minus the location of the first local peak is from greater than or equal to 0.5 cm⁻¹ to less than or equal to 3.8 cm⁻¹.

Aspect 5. The glass-based substrate of any one of aspects 1-4, wherein the depletion layer comprises greater than or equal to 10 mol % more silica than the bulk.

Aspect 6. The glass-based substrate of any one of aspects 1-5, wherein the depletion layer comprises a maximum silica concentration from 80 mol % to 95 mol %.

Aspect 7. The glass-based substrate of any one of aspects 1-6, wherein the depletion layer comprises alumina in an amount that is less than or equal to 50% of an alumina concentration in the bulk.

Aspect 8. The glass-based substrate of any one of aspects 1-7, wherein the depletion layer comprises one or more alkali metal oxides in an amount that is less than or equal to 25% of a corresponding concentration of the one or more alkali metal oxides in the bulk.

Aspect 9. The glass-based substrate of any one of aspects 1-8, wherein the depletion layer comprises one or more alkaline earth metal oxides in an amount that is less than or equal to 25% of a corresponding concentration of the one or more alkaline earth metal oxides in the bulk.

Aspect 10. The glass-based substrate of any one of aspects 1-6, wherein the first depth is from 5 nanometers to 50 nanometers.

Aspect 11. The glass-based substrate of any one of aspects 1-7, wherein the first depth is from 5 nanometers to 12 nanometers.

Aspect 12. The glass-based substrate of any one of aspects 1-7, wherein the first depth is from 12 nanometers to 50 nanometers.

Aspect 13. The glass-based substrate of any one of aspects 10-12, wherein a concentration of silica at 3 nanometers from the first major surface is from 80 mol % to 95 mol %.

Aspect 14. The glass-based substrate of any one of aspects 10-12, wherein a concentration of silica at 3 nanometers from the first major surface is from 90 mol % to 95 mol %.

Aspect 15. The glass-based substrate of any one of aspects 10-14, wherein a concentration of alumina at 3 nanometers from the first major surface is greater than or equal to 10 mol %.

Aspect 16. The glass-based substrate of any one of aspects 10-14, wherein a concentration of alumina at 3 nanometers from the first major surface is less than or equal to 50% of a concentration of alumina in the bulk.

Aspect 17. The glass-based substrate of any one of aspects 10-16, wherein a concentration of one or more alkali metal oxides at a 3 nanometers from the first major surface is less than or equal to 25% of a corresponding concentration of the one or more alkali metal oxides in the bulk.

Aspect 18. The glass-based substrate of any one of aspects 10-17, wherein a concentration of one or more alkaline earth metal oxides at a 3 nanometers from the first major surface is less than or equal to 25% of a corresponding concentration of the one or more alkaline earth metal oxides in the bulk.

Aspect 19. The glass-based substrate of any one of aspects 1-18, wherein a surface roughness Ra of the first major surface is from 0.3 nanometers to 1.0 nanometers.

Aspect 20. The glass-based substrate of any one of aspects 1-19, wherein the first major surface exhibits a kinetic coefficient of friction from 0.01 to 0.12.

Aspect 21. The glass-based substrate of aspect 20, wherein the kinetic coefficient of friction is from 0.035 to 0.045.

Aspect 22. The glass-based substrate of any one of aspects 1-21, wherein the glass-based substrate exhibits a scratch depth of less than or equal to 20 nanometers for a nanoindentation of 1 milliNewton along a 1000 micrometer path.

Aspect 23. The glass-based substrate of any one of aspects 1-22, wherein the glass-based substrate is substantially unstrengthened.

Aspect 24. The glass-based substrate of any one of aspects 1-23, wherein the substrate thickness is from 30 micrometers to 80 micrometers.

Aspect 25. A glass-based substrate comprising:
a first major surface and a second major surface opposite the first major surface, a substrate thickness defined between the first major surface and the second major surface, and the substrate thickness is from 20 micrometers to 200 micrometers; and
a depletion layer extending from the first major surface to a first depth from the first major surface, the depletion layer is depleted in one or more alkali metal oxide, alkaline earth metal oxide, alumina, or combinations thereof relative to a bulk of the glass-based substrate, the depletion layer is enriched in silica relative to the bulk, and the first depth is from 3 nanometers to 12 nanometers,
wherein the depletion layer exhibits a first local peak in an infrared reflectance spectrum, the bulk exhibits a second local peak in an infrared reflectance spectrum, a location of the first local peak and a location of the second local peak are from 1000 cm⁻¹ to 1070 cm⁻¹, and a difference of the location of the second local peak minus the location of the first local peak is from greater than or equal to 0.4 cm⁻¹ to less than or equal to 3.8 cm⁻¹.

Aspect 26. The glass-based substrate of aspect 25, wherein the depletion layer comprises a maximum silica concentration from 80 mol % to 90 mol %.

Aspect 27. The glass-based substrate of aspect 25, wherein the first depth is from 5 nanometers to 12 nanometers.

Aspect 28. The glass-based substrate of aspect 27, wherein a concentration of silica at 3 nanometers from the first major surface is from 80 mol % to 90 mol %.

Aspect 29. The glass-based substrate of any one of aspects 27-28, wherein a concentration of alumina at 3 nanometers from the first major surface is greater than or equal to 10 mol %.

Aspect 30. The glass-based substrate of any one of aspects 27-29, wherein a concentration of one or more alkali metal oxides at a 3 nanometers from the first major surface is less than or equal to 25% of a corresponding concentration of the one or more alkali metal oxides in the bulk.

Aspect 31. The glass-based substrate of any one of aspects 27-30, wherein a concentration of one or more alkaline earth metal oxides at a 3 nanometers from the first major surface is less than or equal to 25% of a corresponding concentration of the one or more alkaline earth metal oxides in the bulk.

Aspect 32. The glass-based substrate of any one of aspects 25-31, wherein a surface roughness Ra of the first major surface is from 0.3 nanometers to 1.0 nanometers.

Aspect 33. The glass-based substrate of any one of aspects 25-32, wherein the first major surface exhibits a kinetic coefficient of friction from 0.01 to 0.12.

Aspect 34. The glass-based substrate of aspect 33, wherein the kinetic coefficient of friction is from 0.035 to 0.045.

Aspect 35. The glass-based substrate of any one of aspects 25-34, wherein the glass-based substrate exhibits a scratch depth of less than or equal to 20 nanometers for a nanoindentation of 1 milliNewton along a 1000 micrometer path.

Aspect 36. The glass-based substrate of any one of aspects 25-35, wherein the glass-based substrate is substantially unstrengthened.

Aspect 37. The glass-based substrate of any one of aspects 25-36, wherein the substrate thickness is from 30 micrometers to 80 micrometers.

Aspect 38. A glass-based substrate comprising:
a first major surface and a second major surface opposite the first major surface, a substrate thickness defined between the first major surface and the second major surface, and the substrate thickness is from 20 micrometers to 200 micrometers; and
a depletion layer extending from the first major surface to a first depth from the first major surface, the depletion layer is depleted in one or more alkali metal oxide, alkaline earth metal oxide, alumina, or combinations thereof relative to a bulk of the glass-based substrate, the depletion layer is enriched in silica relative to the bulk, and the first depth is from 12 nanometers to 75 nanometers,
wherein the depletion layer exhibits a first local peak in an infrared reflectance spectrum, the bulk exhibits a second local peak in an infrared reflectance spectrum, a location of the first local peak and a location of the second local peak are from 1000 cm⁻¹ to 1070 cm⁻¹, and a difference of the location of the second local peak minus the location of the first local peak is greater than or equal to 0.4 cm⁻¹.

Aspect 39. The glass-based substrate of aspect 38, wherein the difference of the location of the second local peak minus the location of the first local peak is from greater than or equal to 0.5 cm⁻¹ to less than or equal to 5.0 cm⁻¹.

Aspect 40. The glass-based substrate of aspect 38, wherein the difference of the location of the second local peak minus the location of the first local peak is from greater than or equal to 0.4 cm⁻¹ to less than or equal to 3.8 cm⁻¹.

Aspect 41. The glass-based substrate of any one of aspects 38-40, wherein the first depth is from 12 nanometers to 50 nanometers.

Aspect 42. The glass-based substrate of any one of aspects 38-41, wherein the depletion layer comprises greater than or equal to 10 mol % more silica than the bulk.

Aspect 43. The glass-based substrate of any one of aspects 38-42, wherein the depletion layer comprises a maximum silica concentration from 80 mol % to 95 mol %.

Aspect 44. The glass-based substrate of any one of aspects 38-43, wherein the depletion layer comprises alumina in an amount that is less than or equal to 50% of an alumina concentration in the bulk.

Aspect 45 The glass-based substrate of any one of aspects 38-44, wherein the depletion layer comprises one or more alkali metal oxides in an amount that is less than or equal to 25% of a corresponding concentration of the one or more alkali metal oxides in the bulk.

Aspect 46. The glass-based substrate of any one of aspects 38-44, wherein the depletion layer comprises one or more alkaline earth metal oxides in an amount that is less than or equal to 25% of a corresponding concentration of the one or more alkaline earth metal oxides in the bulk.

Aspect 47. The glass-based substrate of any one of aspects 38-46, wherein a concentration of silica at 3 nanometers from the first major surface is from 80 mol % to 95 mol %.

Aspect 48. The glass-based substrate of aspect 47, wherein the concentration of silica at 3 nanometers from the first major surface is from 90 mol % to 95 mol %.

Aspect 49. The glass-based substrate of any one of aspects 38-48, wherein a concentration of alumina at 3 nanometers from the first major surface is less than or equal to 50% of a concentration of alumina in the bulk.

Aspect 50. The glass-based substrate of any one of aspects 38-49, wherein a concentration of one or more alkali metal oxides at a 3 nanometers from the first major surface is less than or equal to 25% of a corresponding concentration of the one or more alkali metal oxides in the bulk.

Aspect 51. The glass-based substrate of any one of aspects 38-50, wherein a concentration of one or more alkaline earth metal oxides at a 3 nanometers from the first major surface is less than or equal to 25% of a corresponding concentration of the one or more alkaline earth metal oxides in the bulk.

Aspect 52. The glass-based substrate of any one of aspects 38-51, wherein a surface roughness Ra of the first major surface is from 0.3 nanometers to 1.0 nanometers.

Aspect 53. The glass-based substrate of any one of aspects 38-52, wherein the first major surface exhibits a kinetic coefficient of friction from 0.01 to 0.12.

Aspect 54. The glass-based substrate of aspect 53, wherein the kinetic coefficient of friction is from 0.035 to 0.045.

Aspect 55. The glass-based substrate of any one of aspects 38-54, wherein the glass-based substrate exhibits a scratch depth of less than or equal to 20 nanometers for a nanoindentation of 1 milliNewton along a 1000 micrometer path.

Aspect 56. The glass-based substrate of any one of aspects 38-55, wherein the glass-based substrate is substantially unstrengthened.

Aspect 57. The glass-based substrate of any one of aspects 38-56, wherein the substrate thickness is from 30 micrometers to 80 micrometers.

Aspect 58. The glass-based substrate of any one of aspects 1-57, wherein a composition of the bulk comprises:
from 40 mol % to 80 mol % SiO₂;
from 5 mol % to 30 mol % Al₂O₃;
from 0 mol % to 10 mol % B₂O₃;
from 0 mol % to 5 mol % ZrO₂;
from 0 mol % to 15 mol % P₂O₅;
from 0 mol % to 20 mol % R₂O, R₂O is a total amount of Li₂O, Na₂O, K₂O, Rb₂O, and Cs₂O; and
from 0 mol % to 15 mol % RO, RO is a total amount of MgO, CaO, SrO, BaO, and ZnO.

Aspect 59. The glass-based substrate of aspect 58, wherein the composition of the bulk comprises:
from 63 mol % to 72 mol % SiO₂;
from 8 mol % to 15 mol % Al₂O₃;
from 0 mol % to 2 mol % B₂O₃;
from 0 mol % to 2 mol % P₂O₅;
from 12 mol % to 18 mol % R₂O; and
from 3 mol % to 7 mol % RO.

Aspect 60. The glass-based substrate of any one of aspects 58-59, wherein the composition of the bulk comprises:
from 12 mol % to 18 mol % Na₂O;
from 0 mol % to 1 mol % Li₂O; and
from 0 mol % to 0.5 mol % K₂O.

Aspect 61. The glass-based substrate of any one of aspects 58-60, wherein the composition of the bulk exhibits Al₂O₃—Na₂O from greater than or equal to −6.0 mol % to less than or equal to −2 mol %.

Aspect 62. A consumer electronic product comprising:
a housing comprising a front surface, a back surface, and a side surface;
electrical components at least partially within the housing, the electrical components comprising a controller, a memory, and a display, the display at or adjacent the front surface of the housing; and
a cover substrate disposed over the display,
wherein at least one of a portion of the housing comprises the glass-based substrate of any one of aspects 1-61.

Aspect 63. A method of making a glass-based substrate comprising:
contacting an initial glass-based substrate with an etchant to reduce a thickness of the initial glass-based substrate and form at least a first major surface; and then
contacting the first major surface with a treatment solution to form the glass-based substrate with a substrate thickness from 20 micrometers to 200 micrometers,
wherein the contacting with the etchant and the treatment solution forms a depletion layer extending from the first major surface to a first depth from the first major surface, the depletion layer is depleted in one or more alkali metal oxide, alkaline earth metal oxide, alumina, or combinations thereof relative to a bulk of the glass-based substrate, the depletion layer is enriched in silica relative to the bulk, and the first depth is from 1 nanometer to 75 nanometers, the depletion layer exhibits a first local peak in an infrared reflectance spectrum, the bulk exhibits a second local peak in an infrared reflectance spectrum, a location of the first local peak and a location of the second local peak are from 1000 cm⁻¹ to 1070 cm⁻¹, and a difference of the location of the second local peak minus the location of the first local peak is greater than or equal to 0.4 cm⁻¹.

Aspect 64. The method of aspect 63, wherein the etchant comprises HF.

Aspect 65. The method of any one of aspects 63-64, wherein the treatment solution comprises an alkaline detergent solution.

Aspect 66. The method of any one of aspects 63-65, wherein the treatment solution comprises an alkaline detergent in a concentration from 0.1 wt % to 6.0 wt %.

Aspect 67. The method of aspect 66, wherein the concentration of the alkaline detergent is from 0.1 wt % to 0.5 wt %.

Aspect 68. The method of any one of aspects 63-67, wherein a pH of the treatment solution at 30° C. is from 12.5 to 13.0.

Aspect 69. The method of any of aspects 63-68, wherein the glass-based substrate is substantially unstrengthened.

Aspect 70. The method of any one of aspects 63-69, wherein the first depth is from 5 nanometers to 50 nanometers.

Aspect 71. The method of aspect 70, wherein a concentration of silica at 3 nanometers from the first major surface is from 80 mol % to 95 mol %.

Aspect 72. The method of any one of aspects 70-71, wherein a concentration of alumina at 3 nanometers from the first major surface is greater than or equal to 10 mol %.

Aspect 73. The method of any one of aspects 70-72, wherein a concentration of alumina at 3 nanometers from the first major surface is less than or equal to 50% of a concentration of alumina in the bulk.

Aspect 74. The method of any one of aspects 70-73, wherein a concentration of one or more alkali metal oxides at a 3 nanometers from the first major surface is less than or equal to 25% of a corresponding concentration of the one or more alkali metal oxides in the bulk.

Aspect 75. The method of any one of aspects 70-74, wherein a concentration of one or more alkaline earth metal oxides at a 3 nanometers from the first major surface is less than or equal to 25% of a corresponding concentration of the one or more alkaline earth metal oxides in the bulk.

Aspect 76. The method of any one of aspects 63-75, wherein a composition of the bulk comprises:
from 40 mol % to 80 mol % SiO₂;
from 5 mol % to 30 mol % Al₂O₃;
from 0 mol % to 10 mol % B₂O₃;
from 0 mol % to 5 mol % ZrO₂;
from 0 mol % to 15 mol % P₂O₅;
from 0 mol % to 20 mol % R₂O, R₂O is a total amount of Li₂O, Na₂O, K₂O, Rb₂O, and Cs₂O; and
from 0 mol % to 15 mol % RO, RO is a total amount of MgO, CaO, SrO, BaO, and ZnO.

Aspect 77. The method of aspect 76, wherein the composition of the bulk comprises:
from 63 mol % to 72 mol % SiO₂;
from 8 mol % to 15 mol % Al₂O₃;
from 0 mol % to 2 mol % B₂O₃;
from 0 mol % to 2 mol % P₂O₅;
from 12 mol % to 18 mol % R₂O; and
from 3 mol % to 7 mol % RO.

Aspect 78. The method of any one of aspects 76-77, wherein the composition of the bulk comprises:
from 12 mol % to 18 mol % Na₂O;
from 0 mol % to 1 mol % Li₂O; and
from 0 mol % to 0.5 mol % K₂O.

Aspect 79. The method of any one of aspects 76-78, wherein the composition of the bulk exhibits Al₂O₃—Na₂O from greater than or equal to −6.0 mol % to less than or equal to −2 mol %.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### BRIEF DESCRIPTION OF THE DRAWINGS

The above and other features and advantages of aspects of the present disclosure are better understood when the following detailed description is read with reference to the accompanying drawings, in which:

FIG. 1 is a schematic view of an example glass-based substrate in accordance with aspects of the present disclosure;

FIG. 2 is an enlarged view 2 of FIG. 1 depicting a depletion layer in accordance with aspects of the present disclosure;

FIG. 3 is a schematic plan view of an example consumer electronic device according to aspects;

FIG. 4 is a schematic perspective view of the example consumer electronic device of FIG. 3;

FIG. 5 schematically illustrates a step in a method of making a glass-based substrate comprising reducing the thickness with an etchant;

FIG. 6 schematically illustrates a step in a method of making a glass-based substrate comprising contacting the first major surface with a treatment solution;

FIG. 7 schematically illustrates a cross-sectional view of Example 1 taken using transmission electron microscopy (TEM);

FIG. 8A schematically illustrates a cross-sectional view of Example 4 taken using transmission electron microscopy (TEM);

FIG. 8B schematically illustrates a cross-sectional view of Example 6 taken using transmission electron microscopy (TEM);

FIG. 9 schematically illustrates concentration in mol % on the vertical axis (e.g., y-axis) as a function of depth d from the first major surface in nanometers on the horizontal axis (e.g., x-axis) for various oxides for Examples 1, 3, and 5;

FIG. 10 schematically illustrates concentration in mol % on the vertical axis (e.g., y-axis) as a function of depth d from the first major surface in nanometers on the horizontal axis (e.g., x-axis) for various oxides for Example 4;

FIG. 11 schematically illustrates concentration in mol % of SiO₂ on the vertical axis (e.g., y-axis) as a function of depth d from the first major surface in nanometers on the horizontal axis (e.g., x-axis) for Examples 1, 3, 5, and 6;

FIG. 12 schematically illustrates a distribution of scratch depth SD in nanometers on the vertical axis (e.g., y-axis) for Examples 1-6; and

FIG. 13 schematically illustrates a distribution of kinetic coefficient of friction KCOF on the vertical axis (e.g., y-axis) for Examples 1-6.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, claims may encompass many different aspects of various aspects and should not be construed as limited to the aspects set forth herein.

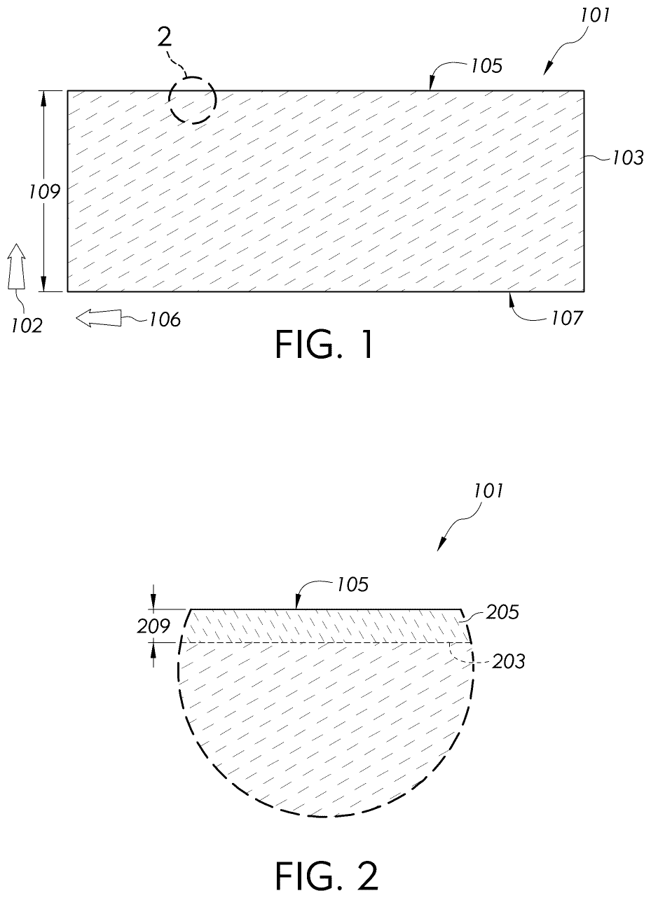

FIG. 1 illustrates a schematic view of a glass-based substrate 101 comprising a substrate 103 in accordance with aspects of the disclosure. Unless otherwise noted, a discussion of features of aspects of one glass-based substrate can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

As shown in FIG. 1, the glass-based substrate 101 comprises a substrate 103 having a first major surface 105 and a second major surface 107 opposite the first major surface 105. In aspects, the first major surface 105 can extend along a first plane, and/or the second major surface 107 can extend along a second plane. In further aspects, the second major surface 107 (e.g., second plane) can be substantially parallel to the first major surface 105 (e.g., first plane). As used herein, a substrate thickness 109 of the glass-based substrate 101 is defined between the first major surface 105 and the second major surface 107 as an average distance therebetween. With reference to FIG. 1, the distance between the first major surface 105 and the second major surface 107 is measured in a thickness direction 102 at a plurality of locations (e.g., at least 20 locations spaced along the width direction 106) and those measurements are averaged to calculate to the substrate thickness 109. In aspects, the glass-based substrate 101 can be an ultra-thin substrate, meaning that the substrate thickness 109 is 200 micrometers or less. In aspects, the substrate thickness 109 can be 20 micrometers (μm) or more, 25 μm or more, 30 μm or more, 35 μm or more, 40 μm or more, 45 μm or more, 50 μm or more, 60 μm or more, 75 μm or more, 100 μm or more, 200 μm or less, 180 μm or less, 160 μm or less, 140 μm or less, 120 μm or less, 100 μm or less, 80 μm or less, 60 μm or less, 50 μm or less, or 40 μm or less. In aspects, the substrate thickness 109 can range from greater than or equal to 20 μm to less than or equal to 200 μm, from greater than or equal to 25 μm to less than or equal to 180 μm, from greater than or equal to 30 μm to less than or equal to 160 μm, from greater than or equal to 35 μm to less than or equal to 140 μm, from greater than or equal to 40 μm to less than or equal to 120 μm, from greater than or equal to 45 μm to less than or equal to 100 μm, from greater than or equal to 50 μm to less than or equal to 80 μm, from greater than or equal to 50 μm to less than or equal to 60 μm, or any range or subrange therebetween. In aspects, the substrate thickness 109 can be 100 μm or less, for example in a range from greater than or equal to 20 μm to less than or equal to 100 μm, from greater than or equal to 25 μm to less than or equal 80 μm, from greater than or equal to 25 μm to less than or equal 60 μm, from greater than or equal to 30 μm to less than or equal 50 μm, from greater than or equal to 30 μm to less than or equal 40 μm, from greater than or equal to 35 μm to less than or equal to 40 μm, or any range or subrange therebetween. In preferred aspects, the substrate thickness 109 can be in a range from greater than or equal to 20 μm to less than or equal to 200 μm, from greater than or equal to 25 μm to less than or equal to 80 μm, or from greater than or equal to 30 μm to less than or equal to 60 μm. In aspects, as shown, a local thickness of the glass-based substrate 101 can be substantially uniform (e.g., substantially equal to the substrate thickness 109) across the first major surface 105 and/or the second major surface 107.

Glass-based substrates 101 can have a pencil hardness of 8H or more, for example, 9H or more. As used herein, pencil hardness is measured using ASTM D 3363-20 with standard lead graded pencils. Throughout the disclosure, the Young's modulus of the glass-based materials is measured using the resonant ultrasonic spectroscopy technique set forth in ASTM E2001-13, titled “Standard Guide for Resonant Ultrasound Spectroscopy for Defect Detection in Both Metallic and Non-metallic Parts.” In aspects, the glass-based substrate can comprise an elastic modulus in a range from 60 GPa to 120 GPa, from 70 GPa to 100 GPa, from 72 GPa to 80 GPa, or any range or subrange therebetween.

As used herein, “glass-based” includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Exemplary glass-based materials, which may be free of lithia or not, comprise soda lime glass, alkali aluminosilicate glass, alkali-containing borosilicate glass, alkali-containing aluminoborosilicate glass, alkali-containing phosphosilicate glass, and alkali-containing aluminophosphosilicate glass. In one or more aspects, a glass-based material may comprise, in mole percent (mol %): SiO₂ from 40 mol % to 80 mol %, Al₂O₃ from 5 mol % to 30 mol %, B₂O₃ from 0 mol % to 10 mol %, ZrO₂ from 0 mol % to 5 mol %, P₂O₅ from 0 mol % to 15 mol %, TiO₂ from 0 mol % to 2 mol %, R₂O from 0 mol % to 20 mol %, and RO from 0 mol % to 15 mol %. As used herein, R₂O refers to a total amount of alkali metal oxides (i.e., Li₂O, Na₂O, K₂O, Rb₂O, and Cs₂O). As used herein, RO refers to a total amount of alkaline earth oxides (i.e., MgO, CaO, SrO, and BaO) and ZnO. In aspects, a glass-based substrate may optionally further comprise from 0 mol % to 2 mol % of each of Na₂SO₄, NaCl, NaF, NaBr, K₂SO₄, KCl, KF, KBr, As₂O₃, Sb₂O₃, SnO₂, Fe₂O₃, and manganese oxides. “Glass-ceramics” include materials produced through controlled crystallization of glass. In aspects, glass-ceramics have from 1% to 99% crystallinity (by volume). Examples of suitable glass-ceramics may include Li₂O—Al₂O₃—SiO₂ system (i.e., LAS-System) glass-ceramics, MgO—Al₂O₃—SiO₂ system (i.e., MAS-System) glass-ceramics, ZnO×Al₂O₃×nSiO₂ (i.e., ZAS system), and/or glass-ceramics that include a predominant crystal phase including β-quartz solid solution, β-spodumene, cordierite, petalite, and/or lithium disilicate. In aspects, the glass-based substrate can be substantially amorphous and/or entirely amorphous, meaning that the glass-based substrate contains less than 1 vol % or 0 vol %, respectively, of crystals.

In aspects, the glass-based substrate 101 has SiO₂ is the largest constituent and, as such, SiO₂ is the primary constituent of the glass network formed from the glass-based composition. Pure SiO₂ has a relatively low CTE. However, pure SiO₂ has a high melting point. Accordingly, if the concentration of SiO₂ in the glass-based composition is too high, the formability of the glass-based composition may be diminished as higher concentrations of SiO₂ increase the difficulty of melting the glass, which, in turn, adversely impacts the formability of the composition. If the concentration of SiO₂ in the glass-based composition is too low the chemical durability of the glass-based material may be diminished, and the glass-based material may be susceptible to surface damage during post-forming treatments. In aspects, the glass-based substrate can comprise SiO₂ in an amount of 60 mol % or more, 62 mol % or more, 63 mol % or more, 63.5 mol % or more, 64.0 mol % or more, 64.5 mol % or more, 65.0 mol % or more, 66.0 mol % or more, 67.0 mol % or more, 68.0 mol % or more, 80 mol % or less, 75 mol % or less, 72 mol % or less, 71.0 mol % or less, 70.5 mol % or less, 70.0 mol % or less, 69.5 mol % or less, 69.0 mol % or less, 68.0 mol % or less, 67.0 mol % or less, or 66.0 mol % or less. In aspects, the glass-based substrate can comprise SiO₂ in a range from greater than or equal to 60 mol % to less than or equal to 80 mol %, from greater than or equal to 62 mol % to less than or equal to 75 mol %, from greater than or equal to 63 mol % to less than or equal to 72 mol %, from 63.5 mol % to less than or equal to 71.0 mol %, from greater than or equal to 64.0 mol % to less than or equal to 70.5 mol %, from greater than or equal to 64.5 mol % to less than or equal to 70.0 mol %, from greater than or equal to 65.0 mol % to less than or equal to 69.5 mol %, from greater than or equal to 66.0 mol % to less than or equal to 69.0 mol %, from greater than or equal to 67.0 mol % to less than or equal to 68.0 mol %, or any range or subrange therebetween. In preferred aspects, the glass-based substrate comprises SiO₂ in an amount from greater than or equal to 60 mol % to less than or equal to 80 mol %, from greater than or equal to 63 mol % to less than or equal to 72 mol %, or from greater than or equal to 64.0 mol % to less than or equal to 70.0 mol %.

The glass-based substrate 101 can include Al₂O₃. Al₂O₃ may serve as a glass network former, similar to SiO₂. Al₂O₃ may increase the viscosity of the glass-based composition due to its tetrahedral coordination in a glass melt formed from a glass-based composition, decreasing the formability of the glass-based composition when the amount of Al₂O₃ is too high. However, when the concentration of Al₂O₃ is balanced against the concentration of SiO₂ and the concentration of alkali oxides in the glass-based composition, Al₂O₃ can reduce the liquidus temperature of the glass melt, thereby enhancing the liquidus viscosity and improving the compatibility of the glass-based composition with certain forming processes. The inclusion of Al₂O₃ in the glass-based compositions can enable the high fracture toughness values described herein. In aspects, the glass-based substrate comprises Al₂O₃ in a concentration of 5 mol % or more, 7 mol % or more, 8 mol % or more, 9 mol % or more, 9.5 mol % or more, 10.0 mol % or more, 11.0 mol % or more, 12.0 mol % or more, 13.0 mol % or more, 30 mol % or less, 25 mol % or less, 20 mol % or less, 17 mol % or less, 15 mol % or less, 14.5 mol % or less, 14.0 mol % or less, 13.0 mol % or less, 12.0 mol % or less, or 11.0 mol % or less. In aspects, the glass-based substrate can comprise an amount of Al₂O₃ in a range from greater than or equal to 5 mol % to less than or equal to 30 mol %, from greater than or equal to 5 mol % to less than or equal to 25 mol %, from greater than or equal to 7 mol % to less than or equal to 20 mol %, from greater than or equal to 7 mol % to less than or equal to 17 mol %, from greater than or equal to 8 mol % to less than or equal to 15 mol %, from greater than or equal to 9 mol % to less than or equal to 15 mol %, from greater than or equal to 9.5 mol % to less than or equal to 14.5 mol %, from greater than or equal to 10.0 mol % to less than or equal to 14.5 mol %, from greater than or equal to 11.0 mol % to less than or equal to 14.0 mol %, from greater than or equal to 12.0 mol % to less than or equal to 13.0 mol %, or any range or subrange therebetween. In preferred aspects, the glass-based substrate comprises Al₂O₃ in an amount from greater than or equal to 5 mol % to less than or equal to 30 mol %, from greater than or equal to 8 mol % to less than or equal to 15 mol %, or from greater than or equal to 9.5 mol % to less than or equal to 14.5 mol %.

The glass-based substrate 101 can include Na₂O. Na₂O may improve the formability, and thereby manufacturability, of the glass-based composition. However, if too much Na₂O is added to the glass-based composition, the melting point may be too high. In aspects, the glass-based substrate comprises Na₂O in an amount of 0 mol % or more, 5 mol % or more, 10 mol % or more, 12 mol % or more, 13 mol % or more, 14.0 mol % or more, 14.5 mol % or more, 15.0 mol % or more, 20 mol % or less, 18 mol % or less, 17.5 mol % or less, 17.0 mol % or less, 16.5 mol % or less, 16.0 mol % or less, 15.5 mol % or less, or 15 mol % or less. In aspects, the glass-based substrate comprises an amount of Na₂O in a range from greater than or equal to 5 mol % to less than or equal to 25 mol %, from greater than or equal to 10 mol % to less than or equal to 20 mol %, from greater than or equal to 12 mol % to less than or equal to 18 mol %, from greater than or equal to 13 mol % to less than or equal to 17.5 mol %, from 14.0 mol % to less than or equal to 17.0 mol %, from greater than or equal to 14.5 mol % to less than or equal to 16.5 mol %, from greater than or equal to 15.0 mol % to less than or equal to 16.5 mol %, from greater than or equal to 15.5 mol % to less than or equal to 16.0 mol %, or any range or subrange therebetween. In preferred aspects, the glass-based substrate comprises Na₂O in an amount from greater than or equal to 12 mol % to less than or equal to 18 mol %, from greater than or equal to 14 mol % to less than or equal to 17 mol %, or from 15.0 mol % to less than or equal to 16.5 mol %. In aspects, a total amount of alkali metal oxides R₂O defined as a total amount of Li₂O, Na₂O, K₂O, Rb₂O, and Cs₂O can be within one or more of the ranges discussed above for the amount of Na₂O in this paragraph.

The glass-based substrate 101 may optionally include Li₂O. In aspects, the glass-based substrate can comprise Li₂O in an amount of 0.0 mol % or more, 0.1 mol % or more, 0.25 mol % or more, 0.5 mol % or more, 1.0 mol % or more, 10 mol % or less, 5 mol % or less, 2 mol % or less, 1 mol % or less, 0.5 mol % or less, or 0.3 mol % or less. In aspects, the glass-based substrate can comprise an amount of Li₂O in a range from greater than or equal to 0.0 mol % to less than or equal to 10 mol %, from greater than or equal to 0.0 mol % to less than or equal to 5.0 mol %, from greater than or equal to 0.0 mol % to less than or equal to 1.0 mol %, from greater than or equal to 0.1 mol % to less than or equal to 0.3 mol %, or any range or subrange therebetween. In aspects, the glass-based substrate can be substantially free of (e.g., less than or equal to 0.07 mol % Li₂O that may be present as tramp in raw materials but not intentionally added) or free of Li₂O.

The glass-based substrate 101 may optionally include K₂O. In aspects, the glass-based substrate can comprise K₂O in an amount of 0.0 mol % or more, 0.1 mol % or more, 0.25 mol % or more, 1 mol % or less, 0.5 mol % or less, or 0.3 mol % or less. In aspects, the glass-based substrate can comprise an amount of K₂O in a range from greater than or equal to 0.0 mol % to less than or equal to 1 mol %, from greater than or equal to 0.0 mol % to less than or equal to 0.50 mol %, from greater than or equal to 0.1 mol % to less than or equal to 0.3 mol %, or any range or subrange therebetween. In aspects, the glass-based substrate can be substantially free of (e.g., less than or equal to 0.07 mol % K₂O that may be present as tramp in raw materials but not intentionally added) or free of K₂O. In aspects, Cs₂O and/or Rb₂O can be optionally present within one or more of the ranges discussed above for K₂O in this paragraph, including that the glass-based substrate can be substantially free of or free of Cs₂O and/or Rb₂O.

In aspects, the glass-based substrate 101 can be per-alkaline, meaning that Al₂O₃—R₂O<0 mol %. In further aspects, a value of Al₂O₃—R₂O and/or Al₂O₃—Na₂O can be −1 mol % or more, −2 mol % or more, −2.2 mol % or more, −2.5 mol % or more, −3.0 mol % or more, −4.0 mol % or more, −4.5 mol % or more, −5.0 mol % or more, −7 mol % or less, −6.0 mol % or more, −5.8 mol % or more, −5.5 mol % or more, −5.0 mol % or more, −4.5 mol % or more, −4.0 mol % or more, −3.0 mol % or more, or −2.5 mol % or more. In further aspects, a value of Al₂O₃—R₂O and/or Al₂O₃—Na₂O can be in a range from greater than or equal to −7 mol % to less than or equal to −1 mol %, from greater than or equal to −6.0 mol % to less than or equal to −2 mol %, from greater than or equal to −5.8 mol % to less than or equal to −2.2 mol %, from greater than or equal to −5.5 mol % to less than or equal to −2.5 mol %, from greater than or equal to −5.0 mol % to less than or equal to −3.0 mol %, from greater than or equal to −4.5 mol % to less than or equal to −4.0 mol %, or any range or subrange therebetween. In preferred aspects, Al₂O₃—R₂O and/or Al₂O₃—Na₂O can be from greater than or equal to −6.0 mol % to less than or equal to −2 mol %, or from greater than or equal to −5.8 mol % to less than or equal to greater than or equal to −2.2 mol %.

The glass-based substrate 101 can include MgO. MgO may lower the viscosity of a glass, which enhances the formability and manufacturability of the composition. The inclusion of MgO in a glass-based composition may also improve the strain point and the Young's modulus of the glass-based composition. However, if too much MgO is added to the glass-based composition, the liquidus viscosity may be too low for compatibility with desirable forming techniques. The addition of too much MgO may also increase the density and the CTE of the glass-based composition to undesirable levels. The inclusion of MgO in the glass-based composition also helps improve the fracture toughness. In aspects, the glass-based substrate can comprise MgO in an amount of 2 mol % or more, 3.0 mol % or more, 3.2 mol % or more, 3.5 mol % or more, 4.0 mol % or more, 4.5 mol % or more, 5.0 mol % or more, 7 mol % or less, 6 mol % or less, 5.5 mol % or less, 5.0 mol % or less, 4.9 mol % or less, or 4.5 mol % or less. In aspects, the glass-based substrate can comprise an amount of MgO in a range from greater than or equal to 2 mol % to less than or equal to 7 mol %, from greater than or equal to 2 mol % to less than or equal to 6 mol %, from greater than or equal to 3.0 mol % to less than or equal to 5.5 mol %, from greater than or equal to 3.2 mol % to less than or equal to 5.0 mol %, from greater than or equal to 3.5 mol % to less than or equal to 4.9 mol %, from greater than or equal to 4.0 mol % to less than or equal to 4.5 mol %, or any range or subrange therebetween. In preferred aspects, the composition comprises MgO in an amount from greater than or equal to 2 mol % to less than or equal to 6 mol % or from greater than or equal to 3.0 mol % to less than or equal to 5.5 mol %.

The glass-based substrate 101 described herein may include CaO. CaO may lower the viscosity of a glass, which may enhance the formability, the strain point, and the Young's modulus. However, if too much CaO is added to the glass-based composition, the density and the CTE of the glass-based composition may increase to undesirable levels. The inclusion of CaO in the glass-based composition also improves the fracture toughness. In aspects, the glass-based substrate can comprise CaO in an amount of 0.01 mol % or more, 0.1 mol % or more, 0.2 mol % or more, 0.3 mol % or more, 0.4 mol % or more, 0.5 mol % or more, 0.7 mol % or more, 2.0 mol % or less, 1.5 mol % or less, 1.2 mol % or less, 1.1 mol % or less, 1.0 mol % or less, or 0.9 mol % or less. In aspects, the glass-based substrate can comprise an amount of CaO in a range from greater than or equal to 0.01 mol % to less than or equal to 2.0 mol %, from greater than or equal to 0.1 mol % to less than or equal to 1.5 mol %, from greater than or equal to 0.3 mol % to less than or equal to 1.2 mol %, from greater than or equal to 0.4 mol % to less than or equal to 1.1 mol %, from greater than or equal to 0.5 mol % to less than or equal to 1.0 mol %, from greater than or equal to 0.7 mol % to less than or equal to 1.0 mol %, or any range or subrange therebetween. In preferred aspects, the glass-based substrate comprises CaO in an amount from greater than or equal to 0.01 mol % to less than or equal to 2.0 mol %, from greater than or equal to 0.3 mol % to less than or equal to 1.2 mol %.

A total amount of alkaline earth oxides and ZnO (RO) is a total amount of MgO, CaO, SrO, BaO, and ZnO in the glass-based substrate. In aspects, RO can be within one or more of the ranges discussed above for MgO, for example, from greater than or equal to 3 mol % to less than or equal to 7 mol %. In aspects, the glass-based substrate 101 can optionally comprise SrO, BaO, and/or ZnO. In aspects, an amount of SrO, BaO, and/or ZnO can be within one or more of the ranges discussed above for the amount of CaO. Alternatively or additionally, the glass-based substrate can be substantially free and/or free of one or more of SrO, BaO, and/or ZnO. In further aspects, the glass-based substrate can be substantially free and/or free of each of SrO, BaO, and/or ZnO.

In aspects, the glass-based substrate can optionally comprise P₂O₅ and/or B₂O₃ in a range from greater than or equal to 0 mol % to less than or equal to 2 mol %, from greater than or equal to 0.1 mol % to less than or equal to 1.0 mol %, from greater than or equal to 0.25 mol % to less than or equal to 0.5 mol %, or any range or subrange therebetween. In aspects, the glass-based substrate can be substantially free or free of one or more of P₂O₅, B₂O₃, TiO₂, ZnO, ZrO₂, Ta₂O₅, HfO₂, La₂O₃, and/or Y₂O₃. As used herein, the term “substantially free” means that the component is not purposefully added as a component of the batch material even though the component may be present in the final glass-based composition in very small amounts as a contaminant, such as less than 0.07 mol %. For example, the inclusion of ZrO₂ in the glass-based composition may result in the formation of undesirable zirconia inclusions in the glass-based material, due at least in part to the low solubility of ZrO₂ in the glass-based material. Also, the inclusion of Ta₂O₅, HfO₂, La₂O₃, and/or Y₂O₃ may increase the cost of raw materials associated with the glass-based substrate.

In aspects, the glass-based substrate 101 can comprise from 63 mol % to 72 mol % SiO₂, from 8 mol % to 15 mol % Al₂O₃, from 12 mol % to 18 mol % Na₂O and/or R₂O, from 2 mol % to 7 mol % MgO and/or RO, optionally from 0 mol % to 2 mol % of one or more of Li₂O, CaO, B₂O₃, and/or P₂O₅, and optionally from 0 mol % to 1 mol % K₂O. In further aspects, the glass-based substrate 101 can comprise from 64.0 mol % 70 mol % SiO₂, from 9.5 mol % to 14.5 mol % Al₂O₃, from 14 mol % to 17 mol % Na₂O, from 3.0 mol % to 5.5 mol % MgO, from 0 mol % to 1 mol % of one or more of Li₂O, CaO, B₂O₃, and/or P₂O₅, and from 0.0 mol % to 0.5 mol % K₂O. In further aspects, Al₂O₃—R₂O and/or Al₂O₃—Na₂O can be from −6.0 mol % to −2 mol % or from −5.8 mol % to −2.2 mol %.

In aspects, glass-based materials (including amorphous materials) can be substantially unstrengthened. As used herein, substantially unstrengthened refers to a substrate comprising either no depth of layer, no depth of compression, a depth of layer in a range from 0% to 5% of the substrate thickness, or a depth of compression in a range from 0% to 5% of the substrate thickness. As used herein, the term “strengthened” may refer to a material that has been chemically strengthened, for example, through ion exchange of larger ions for smaller ions in the surface of the substrate. Chemically strengthening may comprise an ion exchange process, where ions in a surface layer are replaced by—or exchanged with—larger ions having the same valence or oxidation state. Chemical strengthening can form a compressive stress region that extends into a portion of the corresponding substrate. As used herein, depth of compression means the depth at which the stress in the chemically-strengthened substrates and/or portions described herein changes from compressive stress to tensile stress. Depth of compression may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the substrate and/or portion is generated by exchanging potassium ions into the substrate, a surface stress meter, for example, the FSM-6000 (Orihara Industrial Co., Ltd. (Japan)), is used to measure depth of compression. Unless specified otherwise, compressive stress (including surface CS) is measured by surface stress meter (FSM) using commercially available instruments, for example the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than about 400 μm, SCALP is used to measure the depth of compression and central tension (CT). Where the stress in the substrate and/or portion is generated by exchanging both potassium and sodium ions into the substrate and/or portion, and the article being measured is thicker than about 400 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the substrate and/or portion (e.g., sodium, potassium). Through the disclosure, when the maximum central tension cannot be measured directly by SCALP (as when the article being measured is thinner than about 400 μm) the maximum central tension can be approximated by a product of a maximum compressive stress and a depth of compression divided by the difference between the thickness of the substrate and twice the depth of compression, wherein the compressive stress and depth of compression are measured by FSM. Throughout the disclosure, an absolute value of compressive stress is reported as compressive stress, and an absolute value of central tensile stress is reported as central tensile stress.

As shown in FIG. 2, the glass-based substrate 101 comprises a depletion layer 205 extending to a depletion depth 203 from the first major surface 105, where the depletion thickness 209 is the average distance that the depletion layer extends from the first major surface 105 (see average depletion depth 203). Although FIG. 2 only shows the depletion layer 205 extending from the first major surface 105, it is to be understood that another depletion layer can be present at (e.g., extending from) the second major surface that can be similar to (e.g., having aspects within one or more of the ranges discussed herein) and/or identical to the depletion layer 205 extending from the first major surface 105. The depletion layer can be a chemically altered surface layer, for example, having one or more of the aspects discussed below. In aspects, the depletion layer 205 can be depleted in one or more of an alkali metal oxide, an alkaline earth metal oxide, alumina, or combinations thereof relative to a bulk of the glass-based substrate 101. For example, the one or more of an alkali metal oxide and/or an alkaline earth metal oxide can be depleted in the depletion layer such that an amount in the depletion layer is less than or equal to 25% of a corresponding concentration of the one or more of an alkali metal oxide and/or an alkaline earth metal oxide in the bulk; and/or alumina can be depleted such that an amount of alumina in the depletion layer is less than or equal to 50% of a corresponding concentration of alumina in the bulk. In aspects, the depletion layer 205 can be enriched in silica relative to the bulk (e.g., the depletion layer can be enriched by 10 mol % or more silica relative to the bulk). For example, a maximum silica concentration in the depletion layer can be from 10 mol % more than the bulk to 99 mol %, from 70 mol % to 97 mol %, from 72 mol % to 95 mol %, from 72 mol % to 94 mol %, from 75 mol % to 93 mol %, from 77 mol % to 92 mol %, from 80 mol % to 91 mol %, from 82 mol % to 90 mol %, from 84 mol % to 88 mol %, or any range or subrange therebetween. As used herein, a “bulk” of the glass-based substrate and a corresponding composition refers to a portion of glass-based substrate away from the surfaces of the glass-based substrate and the composition of that portion. As used herein, compositions are determined using secondary ion mass spectrometry (SIMS). In aspects, the bulk composition can be measured at a location surrounding a midplane of the glass-based substrate positioned equidistant from the first major surface and the second major surface. For example, any depletion layer can be removed (e.g., by etching or mechanical polishing) so that the bulk composition can be more directly measured. In aspects, the bulk composition can be measured at a deepest location measured from the first major surface by SIMS that is at least 20 nanometers deeper than the depletion layer extends. In further aspects, a composition measured at a location surrounding the midplane can be substantially identical and/or identical to a composition at a location 20 nanometers (or deeper) from the first major surface than the depletion layer extends.

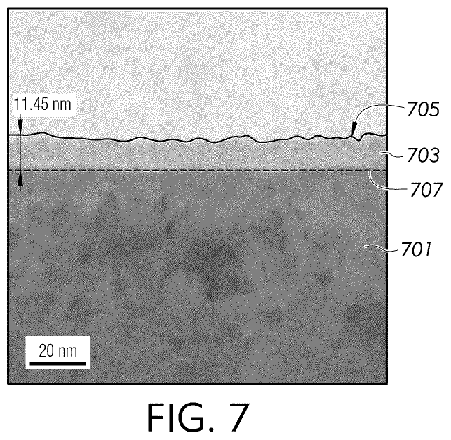

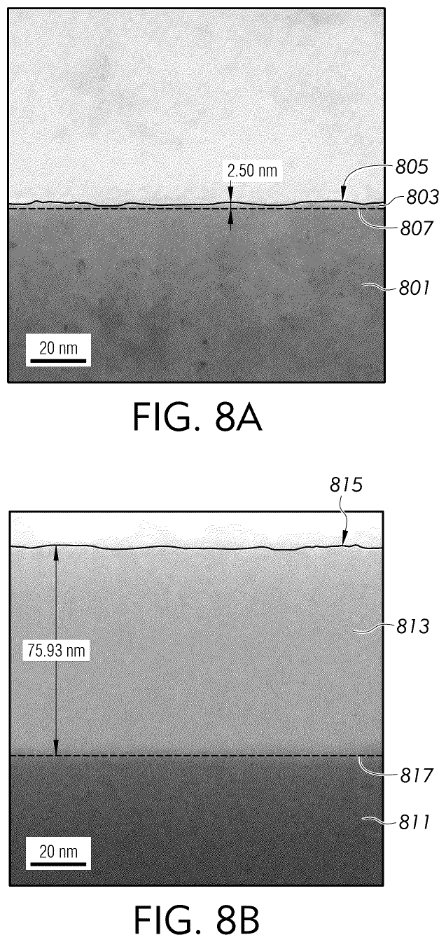

Throughout the disclosure, the thickness of the depletion layer is determined using transmission electron microscopy (TEM). To facilitate imaging a thin lamella of the surface including the depletion layer was taken by focused ion beam (FIB) thinning. As used herein, thickness measurements are performed using a 200 keV STEM high-angle annular dark-field (HAADF). FIGS. 7A-7B and FIG. 8 schematically show TEM images of various examples. As shown, the depletion layer has a markedly different color and appearance than the bulk of the glass-based substrate. As discussed herein, the depletion layer can have a different refractive density and/or density due to the relative depletion (e.g., alkali metal oxides, alkaline earth metals, alumina) and/or enrichment of silica relative to the bulk. It is to be understood that a thickness of the depletion layer can be estimated using other methods including ellipsometry, interferometry (e.g., white light interferometry), and secondary-ion mass-spectrometry (SIMS), the measured thickness from TEM is used as the definitive value of thickness herein.

In aspects, the depletion thickness 209 of the depletion layer 205 (e.g., depletion depth 203) can be 1 nanometer (nm) or more, 3 nm or more, 4 nm or more, 5 nm or more, 6 nm or more, 7 nm or more, 8 nm or more, 9 nm or more, 10 nm or more, 12 nm or more, 15 nm or more, 18 nm or more, 20 nm or more, 25 nm or more, 30 nm or more, 40 nm or more, 50 nm or more, 60 nm or more, 75 nm or less, 70 nm or less, 65 nm or less, 60 nm or less 55 nm or less, 50 nm or less, 45 nm or less, 40 nm or less, 35 nm or less, 30 nm or less, 27 nm or less, 25 nm or less, 22 nm or less, 20 nm or less, 17 nm or less, 15 nm or less, 12 nm or less, 11 nm or less, 10 nm or less, 9 nm or less, 8 nm or less, 7 nm or less, 6 nm or less, or 6 nm or less. In aspects, the depletion thickness 209 of the depletion layer 205 (e.g., average depletion depth 203) can be greater than or equal to 1 nm to less than or equal to 75 nm, from greater than or equal to 3 nm to less than or equal to than or equal to 70 nm, from greater than or equal to 5 nm to less than or equal to 65 nm, from greater than or equal to 5 nm to less than or equal to 60 nm, from greater than or equal to 5 nm to less than or equal to 55 nm, from greater than or equal to 5 nm to less than or equal to 50 nm, from greater than or equal to 6 nm to less than or equal to 45 nm, from greater than or equal to 7 nm to less than or equal to 40 nm, from greater than or equal to 8 nm to less than or equal to 35 nm, from greater than or equal to 9 nm to less than or equal to 30 nm, from greater than or equal to 10 nm to less than or equal to 25 nm, from greater than or equal to 11 nm to less than or equal to 22 nm, from greater than or equal to 12 nm to less than or equal to 20 nm, from greater than or equal to 15 nm to less than or equal to 17 nm, or any range or subrange therebetween. In aspects, the depletion thickness 209 of the depletion layer 205 (e.g., average depletion depth 203) can be 12 nm or less, for example, in a range from greater than or equal to 1 nm to less than or equal to 12 nm, from greater than or equal to 3 nm to less than or equal to 12 nm, from greater than or equal to 5 nm to less than or equal to 12 nm, from greater than or equal to 6 nm to less than or equal to 11 nm, from greater than or equal to 7 nm to less than or equal to 10 nm, from greater than or equal to 8 nm to less than or equal to 9 nm, or any range or subrange therebetween. In aspects, the depletion thickness 209 of the depletion layer 205 (e.g., average depletion depth 203) can be 12 nm or more, for example, from greater than or equal to 12 nm to less than or equal to 75 nm, from greater than or equal to 12 nm to less than or equal to 70 nm, from greater than or equal to 15 nm to less than or equal to 65 nm, from greater than or equal to 15 nm to less than or equal to 60 nm, from greater than or equal to 17 nm to less than or equal to 55 nm, from greater than or equal to 20 nm to less than or equal to 50 nm, from greater than or equal to 25 nm to less than or equal to 45 nm, from greater than or equal to 30 nm to less than or equal to 35 nm, or any range or subrange therebetween. In preferred aspects, the depletion thickness 209 of the depletion layer 205 (e.g., average depletion depth 203) can be from greater than or equal to 1 nm to less than or equal to 75 nm, from greater than or equal to 5 nm to less than or equal to 12 nm, or from greater than or equal to 15 nm to less than or equal to 50 nm. Without wishing to be bound by theory, it is believed that depletion layers greater than 75 nm (e.g., 100 nm or more) can be visible to the naked eye when viewing an image through the glass-based substrate, which can impair a functionality of the glass-based substrate in display-related applications. Also, scratches in thicker depletion layers (e.g., greater than 75 nm, 100 nm or more) can be visible (even when the scratch depth is within the depletion layer but deeper than about 30 nm or more (e.g., 50 nm or more), which can impair an appearance of the glass-based substrate.

In aspects, the depletion layer 205 can be characterized by peaks in the infrared (IR) spectrum, for example, relative to the bulk of the glass-based substrate 101. Throughout the disclosure, the infrared spectrum refers to reflectance spectrum measured by a Fourier transform infrared (FT-IR) spectrometer at an angle of incidence of 10 degrees relative to a direction normal to the first major surface of the sample, where at least 16 scans of the sample are averaged to determine the IR spectrum. Throughout the disclosure, an IR spectrum was obtained using a Nicolet 8700 FT-IR spectrometer with a 10 degrees reflectance accessory and a deuterated triglycine sulfate (DTGS) detector, where 64 scans of the sample at a resolution of 8 cm⁻¹ or finer were averaged to determine the IR spectrum. As used herein, a peak in the IR spectrum was determined using the “Macros Basic” provided as part of the software with the specific FT-IR spectrometer. An IR spectrum of the depletion layer was measured for the (as-formed) first major surface of the glass-based substrate (after any coating disposed thereon has been removed). As used herein, an IR spectrum of the bulk was determined by removing the depletion layer by mechanically polishing 1 micrometer from the first major surface, rinsing the polished substrate in deionized (DI) water at 30° C., and drying the rinsed and polished substrate before measuring the spectrum. It is to be understood that other methods could be used to measure the IR spectrum of the bulk, including (1) removing the depletion layer chemically using an alkaline solution comprising 5 wt % of an alkaline detergent (e.g., using SemiClean KG (Yokohama Oils & Fats Industry Co.) as the alkaline detergent) at 45° C. for at least 1 hour, (2) fracturing the glass-based substrate and measuring one or more of the fractured surfaces, or (3) measuring an IR spectrum of a substrate formed by remelting the sample; however, the IR spectrum of the bulk will be taken to refer to the IR spectrum measured with the chemically removed depletion layer (5 wt % alkaline detergent solution at 45° C. for 1 hour), unless otherwise indicated.

Without wishing to be bound by theory, it is believed that glass-based material (including the bulk of the glass-based substrate and the depletion layer) exhibits a peak in the IR spectrum associated with a Si—O—Si network asymmetric stretch that can occur from 1000 cm⁻¹ to 1070 cm⁻¹. The corresponding peak for fused quartz occurs at 1120 cm⁻¹. A change in this peak in the IR spectrum (e.g., occurring from 1000 cm⁻¹ to 1070 cm⁻¹, from 1000 cm⁻¹ to 1040 cm⁻¹, or from 1005 cm⁻¹ to 1070 cm⁻¹ 1000 cm⁻¹ to 1030 cm⁻¹) is associated with changes in the network structure of the material. In aspects, this peak in the IR spectrum for the depletion layer can be a higher wavenumber (i.e., bulk peak-depletion layer peak >0 cm⁻¹-since wavenumber is the inverse of wavelength) than the corresponding peak in the IR spectrum for the bulk of the same sample (e.g., glass-based substrate).

In aspects, a difference (defined as a location of the peak for the depletion layer minus the location of the peak for the bulk) of the location of the peak in the IR spectrum can be greater than or equal to 0.4 cm⁻¹, greater than or equal to 0.5 cm⁻¹, greater than or equal to 0.6 cm⁻¹, greater than or equal to 0.7 cm⁻¹, greater than or equal to 0.8 cm⁻¹, greater than or equal to 0.9 cm⁻¹, greater than or equal to 1.0 cm⁻¹, greater than or equal to 1.2 cm⁻¹, greater than or equal to 1.5 cm⁻¹, greater than or equal to 1.7 cm⁻¹, greater than or equal to 2.0 cm⁻¹, greater than or equal to 2.2 cm⁻¹, greater than or equal to 2.5 cm⁻¹, less than or equal to 5.0 cm⁻¹, less than or equal to 4.5 cm⁻¹, less than or equal to 4.0 cm⁻¹, less than or equal to 3.8 cm⁻¹, less than or equal to 3.5 cm⁻¹, less than or equal to 3.5 cm⁻¹, less than or equal to 3.2 cm⁻¹, less than or equal to 3.0 cm⁻¹, less than or equal to 2.8 cm⁻¹, less than or equal to 2.5 cm⁻¹, less than or equal to 2.2 cm⁻¹, less than or equal to 2.0 cm⁻¹, less than or equal to 1.8 cm⁻¹, less than or equal to 1.5 cm⁻¹, less than or equal to 1.2 cm⁻¹, less than or equal to 1.0 cm⁻¹, or less than or equal to 0.8 cm⁻¹. In aspects, a difference (defined as a location of the peak for the depletion layer minus the location of the peak for the bulk) of the location of the peak in the IR spectrum can be in a range from greater than or equal to 0.4 cm⁻¹ to less than equal to 5.0 cm⁻¹, from greater than or equal to 0.4 cm⁻¹ to less than or equal to 4.5 cm⁻¹, from greater than or equal to 0.5 cm⁻¹ to less than or equal to 4.0 cm⁻¹, from greater than or equal to 0.5 cm⁻¹ to less than or equal to 3.8 cm⁻¹, from greater than or equal to 0.6 cm⁻¹ to less than or equal to 3.5 cm⁻¹, from greater than or equal to 0.7 cm⁻¹ to less than or equal to 3.2 cm⁻¹, from greater than or equal to 0.8 cm⁻¹ to less than or equal to 3.0 cm⁻¹, from greater than or equal to 0.9 cm⁻¹ to less than or equal to 2.8 cm⁻¹, from greater than or equal to 1.0 cm⁻¹ to less than or equal to 2.5 cm⁻¹, from greater than or equal to 1.2 cm⁻¹ to less than or equal to 2.2 cm⁻¹, from greater than or equal to 1.5 cm⁻¹ to less than or equal to 2.0 cm⁻¹, or any range or subrange therebetween. In preferred aspects, a difference (defined as a location of the peak for the depletion layer minus the location of the peak for the bulk) of the location of the peak in the IR spectrum can be from greater than or equal to 0.4 cm⁻¹ to less than or equal to 5.0 cm⁻¹ or from greater than or equal to 0.5 cm⁻¹ to less than or equal to 3.8 cm⁻¹.

Throughout the disclosure, a composition of the depletion layer and the bulk is quantified by secondary-ion mass-spectroscopy (SIMS). Throughout the disclosure, SIMS was performed using a time-of-flight SIMS (ToF-SIMS) M6 instrument (available from IONTOF GmbH) with a dual beam configuration. The TOF-SIMS M6 instrument is equipped with a Nanoprobe50 bismuth source (30 kilo-electron Volts (keV) Bi³⁺ primary ion beam) with a current of about 0.1 pA for mass spectrometry and a cesium sputter source (2 keV Cs sputter source) with a current of about 120 nA. The bismuth primary ion beam defined an aperture of 400 μm and was operated with a cycle time of 200 μs and a 25 n-s pulse width. The sputter beam was configured to form a 300 μm by 300 μm sputter “crater,” and the analysis beam was configured to impinge a 50 μm by 50 μm area centered in the sputter “crater.” Each analysis frame with the primary ion beam comprised a 64×64 pixel raster over a 50 μm by 50 μm area, and each analysis frame was alternated with 1 second of sputtering with the Cs ion beam. Charge compensation was achieved using an electron flood gun operating at 20 eV electron energy. The chamber was evacuated to a pressure of at least 5×10⁻⁷ Pascals (5×10⁻⁹ millibar) before being brought to and maintained at a pressure of 6×10⁻⁵ Pascals (6×10⁻⁷ millibar) using argon flooding. The detected counts were converted to molar amounts using a predetermined composition of the bulk. The composition of the bulk is determined by: X-ray fluorescence and comparison with standard samples for alumina, phosphorous, alkaline earth metals, transition metals (e.g., ZnO, TiO₂, Fe₂O₃, SnO₂), sodium oxide, and potassium oxide; an amount of B₂O₃ is measured using inductively coupled plasma (ICP) methods; an amount of lithium oxide (Li₂O) is measured using flame emission spectroscopy; and an amount of SiO₂ is taken as the balance of material (i.e., 100%-materials measured using X-ray fluorescence, ICP, and flame emission spectroscopy), and then the composition is converted from wt % to mol %. The depth from the first major surface can be confirmed by measuring the depth that a center of the sputter crater is recessed from the first major surface (e.g., compared to a pre-sputtering measurement), where the thickness can be estimated through ellipsometry, profilometry (e.g., white-light interferometry, atomic force microscopy (AFM) or definitively measured using TEM (as discussed above). The inventors have observed that the thickness of the depletion layer roughly corresponds to a location where the concentration profile is at a value equal to the mean of the bulk concentration and a surface concentration (measured at 1 nm from the first major surface).

The following paragraphs recite concentrations of components at a specific distance (e.g., 3 nm) from the first major surface (and ratios of such concentrations relative to a concentration in bulk), which is applicable when the depletion layer extends at least 1 nm deeper than that distance (e.g., depletion layer extending to at least 4 nm for the recited concentrations at 3 nm to be applicable). As discussed above, the depletion layer can be enhanced in silica, for example, due to the depletion of other components (relative to the bulk glass). In aspects, a concentration of silica at a location within the depletion layer (e.g., 3 nm, 5 nm, 7 nm from the first major surface) can be greater than the corresponding silica concentration of the bulk by 10 mol % or more, 12 mol % or more, 15 mol % or more, 17 mol % or more, 20 mol % or more, 22 mol % or more, 25 mol % or more, 27 mol % or more, 30 mol % or more, 40 mol % or less, 35 mol % or less, 32 mol % or less, 30 mol % or less, 27 mol % or less, 25 mol % or less, 22 mol % or less, 20 mol % or less, 17 mol % or less, or 15 mol % or less. In aspects, a concentration of silica at a location within the depletion layer (e.g., 3 nm, 5 nm, or 7 nm from the first major surface) can be greater than the corresponding silica concentration of the bulk by an amount from greater than or equal to 10 mol % to less than or equal to 40 mol %, from greater than or equal to 12 mol % to less than or equal to 35 mol %, from greater than or equal to 15 mol % to less than or equal to 32 mol %, from greater than or equal to 17 mol % to less than or equal to 30 mol %, from greater than or equal to 20 mol % to less than or equal to 27 mol %, from greater than or equal to 22 mol % to less than or equal to 25 mol %, or any range or subrange therebetween. In aspects, a concentration of silica at a distance (e.g., 3 nm, 5 nm, or 7 nm from the first major surface) within the depletion layer can be 70 mol % or more, 72 mol % or more, 75 mol % or more, 77 mol % or more, 80 mol % or more, 82 mol % or more, 84 mol % or more, 86 mol % or more, 88 mol % or more, 90 mol % or more, 91 mol % or more, 92 mol % or more, 93 mol % or more, 95 mol % or less, 94 mol % or less, 93 mol % or less, 92 mol % or less, 91 mol % or less, 90 mol % or less, 89 mol % or less, 88 mol % or less, 87 mol % or less, 86 mol % or less, 85 mol % or less, 83 mol % or less, or 80 mol % or less. In aspects, a concentration of silica at a distance (e.g., 3 nm, 5 nm, or 7 nm from the first major surface) within the depletion layer can be in a range from greater than or equal to 70 mol % to less than or equal to 95 mol %, from greater than or equal to 72 mol % to less than or equal to 94 mol %, from greater than or equal to 75 mol % to less than or equal to 93 mol %, from greater than or equal to 77 mol % to less than or equal to 92 mol %, from greater than or equal to 80 mol % to less than or equal to 91 mol %, from greater than or equal to 80 mol % to less than or equal to 90 mol %, from greater than or equal to 82 mol % to less than or equal to 89 mol %, from greater than or equal to 84 mol % to less than or equal to 88 mol %, from greater than or equal to 86 mol % to less than or equal to 87 mol %, or any range or subrange therebetween. In further aspects, when the first depth (e.g., thickness of the depletion layer) is from 4 nm to 12 nm (e.g., from 5 nm to 12 nm, from 6 nm to 10 nm, from 7 nm to 9 nm, or any range or subrange therebetween), the concentration of silica at a depth of 3 nm from the first major surface can be less than or equal to 90 mol %, for example, from greater than or equal to 70 mol % to less than or equal to 90 mol %, from greater than or equal to 75 mol % to less than or equal to 90 mol %, from greater than or equal to 80 mol % to less than or equal to 90 mol %, from greater than or equal to 82 mol % to less than or equal to 89 mol %, from greater than or equal to 84 mol % to less than or equal to 88 mol %, from greater than or equal to 86 mol % to less than or equal to 87 mol %, or any range or subrange therebetween. In further aspects, when the first depth (e.g., thickness of the depletion layer) is greater than or equal to 12 nm (e.g., from 12 nm to 75 nm, from 15 nm to 50 nm, from 20 nm to 30 nm, or any range or subrange therebetween), the concentration of silica at a distance of 3 nm, 5 nm, and/or 7 nm from the first major surface can be greater than or equal to 90 mol %, for example, in a range from greater than or equal to 90 mol % to less than or equal to 95 mol %, from greater than or equal to 91 mol % to less than or equal to 94 mol %, from greater than or equal to 92 mol % to less than or equal to 93 mol %, or any range or subrange therebetween.

As discussed above, the depletion layer can be depleted in alumina relative to the bulk. In aspects, a difference between the concentration of alumina in the bulk minus a concentration of alumina at a location within the depletion layer (e.g., 3 nm, 5 nm, 7 nm from the first major surface) can be 1 mol % or more, 2 mol % or more, 3 mol % or more, 4 mol % or more, 5 mol % or more, 6 mol % or more, 7 mol % or more, 8 mol % or more, 9 mol % or more, 10 mol % or less, 8 mol % or less, 7 mol % or less, 6 mol % or less, 5 mol % or less, 4 mol % or less, or 3 mol % or less. In aspects, a difference between the concentration of alumina in the bulk minus a concentration of alumina at a location within the depletion layer (e.g., 3 nm, 5 nm, 7 nm from the first major surface) can be in a range from greater than or equal to 1 mol % to less than or equal to 10 mol %, from greater than or equal to 2 mol % to less than or equal to 8 mol %, from greater than or equal to 3 mol % to less than or equal to 7 mol %, from greater than or equal to 4 mol % to less than or equal to 6 mol %, from greater than or equal to 5 mol % to less than or equal to 6 mol %, or any range or subrange therebetween. In aspects, a concentration of alumina at a location within the depletion layer (e.g., 3 nm, 5 nm, 7 nm from the first major surface), as a percentage of a concentration of alumina in the bulk, can be 50% or less, 45% or less, 40% or less, 35% or less, 30% or less, 10% or more, 15% or more, 20% or more, 25% or more, 30% or more, 35% or more, or 40% or more. In aspects, a concentration of alumina at a location within the depletion layer (e.g., 3 nm, 5 nm, 7 nm from the first major surface), as a percentage of a concentration of alumina in the bulk, can be in a range from greater than or equal to 10% to less than or equal to 50%, from greater than or equal to 15% to less than or equal to 45%, from greater than or equal to 20% to less than or equal to 40%, from greater than or equal to 25% to less than or equal to 35%, from greater than or equal to 30% to less than or equal to 35%, or any range or subrange therebetween. In aspects, a concentration of alumina at a location within the depletion layer (e.g., 3 nm, 5 nm, 7 nm from the first major surface) can be less than a concentration of alumina in the bulk but greater than or equal to 3 mol %, greater than or equal to 5 mol %, greater than or equal to 6 mol %, greater than or equal to 7 mol %, greater than or equal to 8 mol %, greater than or equal to 9 mol %, greater than or equal to 10 mol %, greater than or equal to 11 mol %, greater than or equal to 11 mol %, greater than or equal to 12 mol %, less than or equal to 15 mol %, less than or equal to 13 mol %, less than or equal to 12 mol %, less than or equal to 11 mol %, less than or equal to 10 mol %, less than or equal to 9 mol %, less than or equal to 8 mol %, less than or equal to 7 mol %, less than or equal to 6 mol %, or less than or equal to 5 mol %. In aspects, a concentration of alumina at a location within the depletion layer (e.g., 3 nm, 5 nm, 7 nm from the first major surface) can be less than a concentration of alumina in the bulk and is in a range from greater than or equal to 3 mol % to less than or equal to 15 mol %, from greater than or equal to 5 mol % to less than or equal to 13 mol %, from greater than or equal to 6 mol % to less than or equal to 12 mol %, from greater than 7 mol % to less than or equal to 11 mol %, from greater than or equal to 8 mol % to less than or equal to 10 mol %, from greater than or equal to 9 mol % to less than or equal to 10 mol %, or any range or subrange therebetween. In aspects, when the first depth (e.g., thickness of the depletion layer) is less than or equal to 12 nm (e.g., from 4 nm to 12 nm, from 5 nm to 12 nm, from 6 nm to 10 nm, from 7 nm to 9 nm, or any range or subrange therebetween), a concentration of alumina at a location within the depletion layer (e.g., 3 nm, 5 nm, 7 nm from the first major surface) can be greater than or equal to 10 mol % and less than a concentration of alumina in the bulk, for example, from greater than or equal to 10 mol % to less than or equal to 15 mol %, from greater than or equal to 11 mol % to less than or equal to 13 mol %, from greater than or equal to 11 mol % to less than or equal to 12 mol %, or any range or subrange therebetween.

As discussed above, the depletion layer can be depleted in one or more alkali metal oxides relative to the bulk. The following discussion will focus on sodium oxide (Na₂O), although the ranges can apply to a total amount of alkali metal oxides (R₂O), or other alkali metal oxides if they are present in amounts greater than 0.5 mol % in the bulk. In aspects, a concentration of Na₂O (and/or R₂O) at a location within the depletion layer (e.g., 3 nm, 5 nm, 7 nm from the first major surface), as a percentage of a corresponding concentration (e.g., Na₂O or R₂O) in the bulk, can be 33% or less, 25% or less, 22% or less, 20% or less, 18% or less, 15% or less, 10% or less, 1% or more, 3% or more, 5% or more, 10% or more, 12% or more, 15% or more, or 18% or more. In aspects, a concentration of Na₂O (and/or R₂O) at a location within the depletion layer (e.g., 3 nm, 5 nm, 7 nm from the first major surface), as a percentage of a corresponding concentration (e.g., Na₂O or R₂O) in the bulk, can be in a range from greater than or equal to 1% to less than or equal to 33%, from greater than or equal to 1% to less than or equal to 25%, from greater than or equal to 3% to less than or equal to 22%, from greater than or equal to 5% to less than or equal to 20%, from greater than or equal to 10% to less than or equal to 18%, from greater than or equal to 12% to less than or equal to 15%, or any range or subrange therebetween. In aspects, a difference between the concentration of Na₂O (and/or R₂O) in the bulk minus a corresponding concentration (e.g., Na₂O or R₂O) at a location within the depletion layer (e.g., 3 nm, 5 nm, 7 nm from the first major surface) can be 1 mol % or more, 2 mol % or more, 3 mol % or more, 4 mol % or more, 5 mol % or more, 6 mol % or more, 7 mol % or more, 8 mol % or more, 9 mol % or more, 10 mol % or less, 8 mol % or less, 7 mol % or less, 6 mol % or less, 5 mol % or less, 4 mol % or less, or 3 mol % or less. In aspects, a difference between the concentration of Na₂O (and/or R₂O) in the bulk minus a corresponding concentration (e.g., Na₂O or R₂O) at a location within the depletion layer (e.g., 3 nm, 5 nm, 7 nm from the first major surface) can be in a range from greater than or equal to 1 mol % to less than or equal to 10 mol %, from greater than or equal to 2 mol % to less than or equal to 8 mol %, from greater than or equal to 3 mol % to less than or equal to 7 mol %, from greater than or equal to 4 mol % to less than or equal to 6 mol %, from greater than or equal to 5 mol % to less than or equal to 6 mol %, or any range or subrange therebetween.

As discussed above, the depletion layer can be depleted in one or more alkaline earth metal oxides relative to the bulk. The following discussion will focus on magnesium oxide (MgO), although the ranges can apply to a total amount of alkaline metal oxides (RO), or other alkaline metal oxides (e.g., CaO, SrO, BaO) if they are present in amounts greater than 0.5 mol % in the bulk. In aspects, a concentration of MgO (and/or CaO and/or RO) at a location within the depletion layer (e.g., 3 nm, 5 nm, 7 nm from the first major surface), as a percentage of a corresponding concentration (e.g., MgO, CaO, and/or RO) in the bulk, can be 33% or less, 25% or less, 22% or less, 20% or less, 18% or less, 15% or less, 10% or less, 1% or more, 3% or more, 5% or more, 10% or more, 12% or more, 15% or more, or 18% or more. In aspects, a concentration of and/or CaO and/or RO at a location within the depletion layer (e.g., 3 nm, 5 nm, 7 nm from the first major surface), as a percentage of a corresponding concentration (e.g., MgO, CaO, or RO) in the bulk, can be in a range from greater than or equal to 1% to less than or equal to 33%, from greater than or equal to 1% to less than or equal to 25%, from greater than or equal to 3% to less than or equal to 22%, from greater than or equal to 5% to less than or equal to 20%, from greater than or equal to 10% to less than or equal to 18%, from greater than or equal to 12% to less than or equal to 15%, or any range or subrange therebetween. In aspects, a difference between the concentration of MgO (and/or CaO and/or RO) in the bulk minus a corresponding concentration (e.g., MgO, CaO, or RO) at a location within the depletion layer (e.g., 3 nm, 5 nm, 7 nm from the first major surface) can be 1 mol % or more, 2 mol % or more, 3 mol % or more, 4 mol % or more, 5 mol % or more, 6 mol % or more, 7 mol % or more, 8 mol % or more, 9 mol % or more, 10 mol % or less, 8 mol % or less, 7 mol % or less, 6 mol % or less, 5 mol % or less, 4 mol % or less, or 3 mol % or less. In aspects, a difference between the concentration of MgO (and/or CaO and/or RO) in the bulk minus a corresponding concentration (e.g., MgO, CaO, or RO) at a location within the depletion layer (e.g., 3 nm, 5 nm, 7 nm from the first major surface) can be in a range from greater than or equal to 1 mol % to less than or equal to 10 mol %, from greater than or equal to 2 mol % to less than or equal to 8 mol %, from greater than or equal to 3 mol % to less than or equal to 7 mol %, from greater than or equal to 4 mol % to less than or equal to 6 mol %, from greater than or equal to 5 mol % to less than or equal to 6 mol %, or any range or subrange therebetween.

As used herein, “surface roughness” means the surface roughness Ra, which is an arithmetical mean of the absolute deviations of a surface profile from an average position in a direction normal to the surface of the test area. Surface roughness Ra is calculated using a surface profile measured for a 2 μm by 2 μm test area using atomic force microscopy (AFM). Throughout the disclosure, the surface roughness Ra was measured using a Dimension Icon AFM (available from Bruker) in tapping mode, where the 2 μm by 2 μm test area was scanned at a rate of 1 Hertz with a resolution of at least 256 by 256 for the test area. The surface roughness Ra of the first major surface was measured without any coating thereon. In aspects, the surface roughness Ra of the first major surface of the glass-based substrate (with the depletion layer extending from the first major surface) can be 0.3 nm or more, 0.4 nm or more, 0.5 nm or more, 0.6 nm or more, 0.7 nm or more, 1.0 nm or less, 0.9 nm or less, 0.8 nm or less, 0.7 nm or less, or 0.5 nm or less. In aspects, the surface roughness Ra of the first major surface of the glass-based substrate (with the depletion layer extending from the first major surface) can be greater than or equal to 0.3 nm to less than or equal to 1.0 nm, from greater than or equal to 0.4 nm to less than or equal to 0.9 nm, from greater than or equal to 0.5 nm to less than or equal to 0.8 nm, from greater than or equal to 0.6 nm to less than or equal to 0.7 nm, or any range or subrange therebetween.

Throughout the disclosure, a “coefficient of friction” refers to a kinetic coefficient of friction (also referred to as a “dynamic coefficient of friction”-in contrast to a static coefficient of friction). Throughout the disclosure, the kinetic coefficient of friction is measured for a stainless steel ball (3.2 millimeter diameter) with a constant applied load (normal force on the first major surface) of 0.5 Newtons that was dragged across the first major surface, where the data after the threshold for static friction had been overcome was averaged to determine the reported kinetic coefficient of friction. As used herein, the kinetic coefficient of friction was measured using a Nanovea mechanical tester (available from Nanovea) using the SiC ball tip, where the first major surface of the glass-based substrate was tested without any coatings thereon. In aspects, the first major surface of the glass-based substrate can exhibit a kinetic coefficient of friction of 0.01 or more, 0.02 or more, 0.025 or more, 0.03 (e.g., 0.030) or more, 0.035 or more, 0.040 or more, 0.045 or more, 0.050 or more, 0.06 or more, 0.07 or more, 0.12 or less, 0.10 or less, 0.08 or less, 0.06 or less, 0.05 or less, 0.045 or less, or 0.040 or less. In aspects, the first major surface of the glass-based substrate can exhibit a kinetic coefficient of friction in a range from greater than or equal to 0.01 to less than or equal to 0.12, from greater than or equal to 0.01 to less than or equal to 0.10, from greater than or equal to 0.02 to less than or equal to 0.08, from greater than or equal to 0.025 to less than or equal to 0.06, from greater than or equal to 0.030 to less than or equal to 0.05 or less, from greater than or equal to 0.035 to less than or equal to 0.045, from greater than or equal to 0.040 to less than or equal to 0.045, or any range or subrange therebetween.

Throughout the disclosure, a scratch depth is measured using nano-indentation, where three scratches have a length of 1000 micrometers were formed on the first major surface with a spacing of 100 micrometers between adjacent scratches, and the scratches were formed with a predetermined applied load (e.g., 0.5 milliNetwons (mN) or 1 mN). Then, a surface profile of the first major surface with the scratch(es) is compared to an initial surface profile of the first major surface before the scratch(es) to determine a profile of the depth along the (e.g., each) 1000 micrometer long path. As used herein, a G200 Nano Indenter (available from KLA Instruments) was used for forming the scratch(es), where a sample of the glass-based substrate was mounted on a glass slide using super glue, where the glass slide is attached to a metal stub of the indenter. In aspects, the glass-based substrate (e.g., first major surface) scratched with an applied load of 1 mN can exhibit a scratch depth of 25 nm or less, 22 nm or less, 20 nm or less, 19 nm or less, 18 nm or less, 17 nm or less, 16 nm or less, 15 nm, 14 nm or less, 13 nm or less, 1 nm or more, 5 nm or more, 8 nm or more, 10 nm or more, 12 nm or more, 14 nm or more, 16 nm or more, 17 nm or more, or 18 nm or more. In aspects, the glass-based substrate (e.g., first major surface) scratched with an applied load of 1 mN can exhibit a scratch depth in a range from greater than or equal to 1 nm to less than or equal to 25 nm, from greater than or equal to 1 nm to less than or equal to 22 nm, from greater than or equal to 5 nm to less than or equal to 20 nm, from greater than or equal to 8 nm to less than or equal to 19 nm, from greater than or equal to 10 nm to less than or equal to 18 nm, from greater than or equal 12 nm to less than or equal to 16 nm, from greater than or equal to 14 nm to less than or equal to 15 nm, or any range or subrange therebetween. In aspects, the glass-based substrate (e.g., first major surface) scratched with an applied load of 0.5 mN can exhibit a scratch depth of 20 nm or less, 18 nm or less, 17 nm or less, 16 nm or less, 15 nm, 14 nm or less, 13 nm or less, 12 nm or less, 10 nm or less, 1 nm or more, 5 nm or more, 8 nm or more, 10 nm or more, 12 nm or more, or 14 nm or more. In aspects, the glass-based substrate (e.g., first major surface) scratched with an applied load of 0.5 mN can exhibit a scratch depth in a range from greater than or equal to 1 nm to less than or equal to 20 nm, from greater than or equal to 1 nm to less than or equal to 18 nm, from greater than or equal to 5 nm to less than or equal to 17 nm, from greater than or equal to 8 nm to less than or equal to 16 nm, from greater than or equal to 10 nm to less than or equal to 15 nm, from greater than or equal to 12 nm to less than or equal to 14 nm, from greater than or equal to 12 nm to less than or equal to 13 nm, or any range or subrange therebetween.

Without wishing to be bound by theory, it is believed that the depletion layer provides enhanced micro-scale scratch resistance to the glass-based substrate. As demonstrated by the Examples below, it appears that the depletion layer reduces the scratch depth for milliNewton scale loads (e.g., 0.5 mN, 1 mN) that can occur incidentally as glass-based substrates are transported, packaged, or otherwise handled during processing and/or shipping. When the scratch depth is less than or equal to the depth of depletion layer (first depth), the scratch may be inhibited (e.g., prevented) from further growth (e.g., propagation) due to the different properties of the depletion layer relative to the bulk of the glass-based substrate. Additionally or alternatively, scratches within the depletion layer may not be visible to the naked eye, which can improve an aesthetic (e.g., cosmetic) appearance of the glass-based substrate relative to glass-based substrate experiencing the same loads (e.g., scratching conditions) without the presence of a depletion layer.

In aspects, although not shown, a coating can be disposed over the first major surface and/or the second major surface of the glass-based substrate. In even further aspects, a coating thickness of the coating can be 0.1 μm or more, 1 μm or more, 5 μm or more, 10 μm or more, 15 μm or more, 20 μm or more, 25 μm or more, 40 μm or more, 50 μm or more, 60 μm or more, 70 μm or more, 80 μm or more, 90 μm or more, 200 μm or less, 100 μm or less, 50 μm or less, 30 μm or less, 25 μm or less, 20 μm or less, 20 μm or less, 15 μm or less, or 10 μm or less. In further aspects, the coating thickness of the coating can range from 0.1 μm to 200 μm, from 1 μm to 100 μm, from 10 μm to 100 μm, from 20 μm to 100 μm, from 30 μm to 100 μm, from 40 μm to 100 μm, from 50 μm to 100 μm, from 60 μm to 100 μm, from 70 μm to 100 μm, from 80 μm to 100 μm, from 90 μm to 100 μm, from 0.1 μm to 50 μm, from 1 μm to 50 μm, from 10 μm to 50 μm, or any range or subrange therebetween.

In aspects, the coating can comprise a polymeric coating. In further aspects, the polymeric coating can comprise one or more of an ethylene-acid copolymer, a polyurethane-based polymer, an acrylate resin, and a mercapto-ester resin. Example aspects of ethylene-acid copolymers include ethylene-acrylic acid copolymers, ethylene-methacrylic acid copolymers, and ethylene-acrylic-methacrylic acid terpolymers (e.g., Nucrel (DuPont)), ionomers of ethylene acid copolymers (e.g., Surlyn (DuPont)), and ethylene-acrylic acid copolymer amine dispersions (e.g., Aquacer (BYK)). Example aspects of polyurethane-based polymers include aqueous modified polyurethane dispersions (e.g., Eleglas (Axalta)). In further aspects, the polymeric coating can comprise ethylene-acrylic acid copolymers and ethylene-methacrylic acid copolymers, which may be ionomerized to form ionomer resins through neutralization of the carboxylic acid residue with typically alkali metal ions, for example sodium, and potassium and also zinc. Such ethylene-acrylic acid and ethylene-methacrylic acid ionomers may be dispersed within water and coated onto the substrate to form an ionomer coating. Alternatively, such acid copolymers may be neutralized with ammonia which, after coating and drying liberates the ammonia to reform the acid copolymer as the coating. By providing a coating comprising a polymeric coating, the glass-based substrate can comprise low energy fracture.

In aspects, the coating, if provided, may also comprise one or more of an easy-to-clean coating, a low-friction coating, an oleophobic coating, a diamond-like coating, a scratch-resistant coating, or an abrasion-resistant coating. A scratch-resistant coating may comprise an oxynitride, for example, aluminum oxynitride or silicon oxynitride with a thickness of 500 micrometers or more. In such aspects, the abrasion-resistant layer may comprise the same material as the scratch-resistant layer. In aspects, a low friction coating may comprise a highly fluorinated silane coupling agent, for example, an alkyl fluorosilane with oxymethyl groups pendant on the silicon atom. In such aspects, an easy-to-clean coating may comprise the same material as the low friction coating. In other aspects, the easy-to-clean coating may comprise a protonatable group, for example an amine, for example, an alkyl aminosilane with oxymethyl groups pendant on the silicon atom. In such aspects, the oleophobic coating may comprise the same material as the easy-to-clean coating. In aspects, a diamond-like coating comprises carbon and may be created by applying a high voltage potential in the presence of a hydrocarbon plasma.

The transmittance and haze values reported herein are measured using a BYK Haze-Gard Dual (BYK Gardner). In aspects, an “optically transparent material” or an “optically clear material” can have an average transmittance of 75% or more, 80% or more, 85% or more, or 90% or more, 92% or more, 93% or more, 94% or more, 95% or more, 96% or more in the wavelength range of 400 nm to 700 nm through a 0.7 mm thick piece of the material. The average transmittance in the wavelength range of 400 nm to 700 nm is calculated by measuring the transmittance of whole number wavelengths from 400 nm to 700 nm and averaging the measurements. In aspects, the glass-based substrate can be optically transparent. In aspects, the glass-based substrate can comprise an average transmittance (averaged over optical wavelengths from 400 nm to 700 nm) of 80% or more, 90% or more, 91% or more, 92.0% or more, 92.2% or more, 92.5% or more, 92.8% or more, 93.0% or more, 99% or less, 96% or less, 95% or less, or 94% or less. In aspects, the glass-based substrate 101 can comprise an average transmittance (averaged over optical wavelengths from 400 nm to 700 nm) can be in a range from 80% to 99%, from 90% to 96%, from 90% to 95%, from 91% to 95%, from 92.0% to 95%, from 92.2% to 94%, from 92.5% to 94%, from 92.8% to 93%, or any range or subrange therebetween.

As used herein, haze refers to transmission haze that is measured through the first major surface 105 in accordance with ASTM D1003-21 at 0° relative to a direction normal to the first major surface 105. Haze is measured using a BYK Haze-Gard Dual (BYK Gardner). A CIE D65 illuminant is used as the light source for illuminating the glass-based substrate 101. Haze values reported herein are measured through a substrate comprising a thickness of 0.7 mm with the light incident on the first major surface 105 being measured as it exits the first major surface 105. In further aspects, the haze of the glass-based substrate 101 can be 5% or less, 2% or less, 1% or less, 0.8% or less, 0.5% or less, or 0.3% or less. In further aspects, the haze of the glass-based substrate 101 can be in a range from 0.01% to 5%, from 0.05% to 2%, from 0.1% to 1%, from 0.1% to 0.8%, from 0.2% to 0.5%, or any range or subrange therebetween.

Throughout the disclosure, refractive index is measured in accordance with ASTM E1967-19, where the first wavelength comprises 589 nm. In aspects, the first refractive index of the glass-based substrate 101 may be 1.4 or more, 1.45 or more, 1.48 or more, 1.49 or more, 1.50 or more, 1.6 or less, 1.57 or less, 1.55 or less, 1.53 or less, or 1.52 or less. In aspects, the first refractive index of the glass-based substrate 101 can range from 1.4 to 1.6, from 1.45 to 1.57, from 1.48 to 1.55, from 1.49 to 1.53, from 1.50 to 1.52, or any range or subrange therebetween.

Aspects of the disclosure can comprise a consumer electronic product. The consumer electronic product can comprise a front surface, a back surface, and side surfaces. The consumer electronic product can further comprise electrical components at least partially within the housing. The electrical components can comprise a controller, a memory, and a display. The display can be at or adjacent to the front surface of the housing. The display can comprise a liquid crystal display (LCD), an electrophoretic display (EPD), an organic light-emitting diode (OLED) display, or a plasma display panel (PDP). The consumer electronic product can comprise a cover substrate disposed over the display. In aspects, at least one of a portion of the housing or the cover substrate comprises the glass-based substrate discussed throughout the disclosure. The consumer electronic product can comprise a portable electronic device, for example, a smartphone, a tablet, a wearable device, or a laptop.

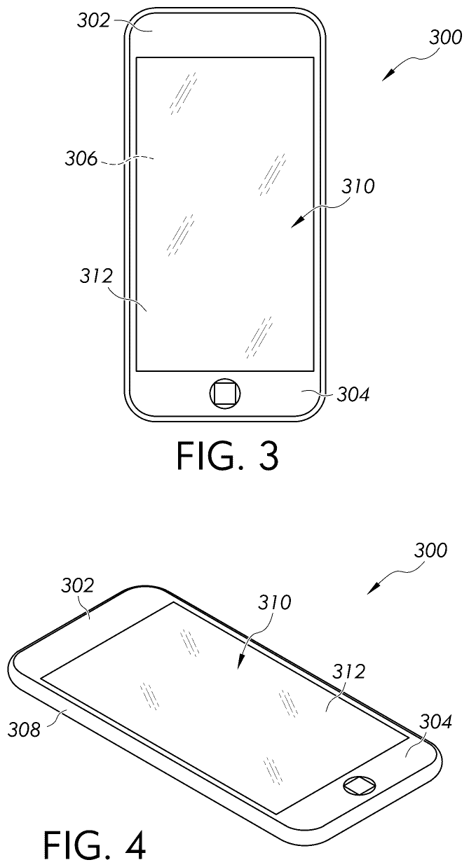

The glass-based substrate disclosed herein may be incorporated into another article, for example, an article with a display (or display articles) (e.g., consumer electronics, including mobile phones, tablets, computers, navigation systems, wearable devices (e.g., watches), and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the glass-based substrate 101 disclosed herein is shown in FIGS. 3-4. Specifically, FIGS. 3-4 show a consumer electronic device 300 including a housing 302 having front 304, back 306, and a side surface(s) 308. Although not shown, the consumer electronic device can comprise electrical components that are at least partially inside or entirely within the housing. For example, electrical components include at least a controller, a memory, and a display. As shown in FIGS. 3-4, the display 310 can be at or adjacent to the front surface of the housing 302. The consumer electronic device can comprise a cover substrate 312 at or over the front surface of the housing 302 such that it is over the display 310. In aspects, at least one of the cover substrate 312 or a portion of housing 302 may include any of the glass-based substrates disclosed herein.

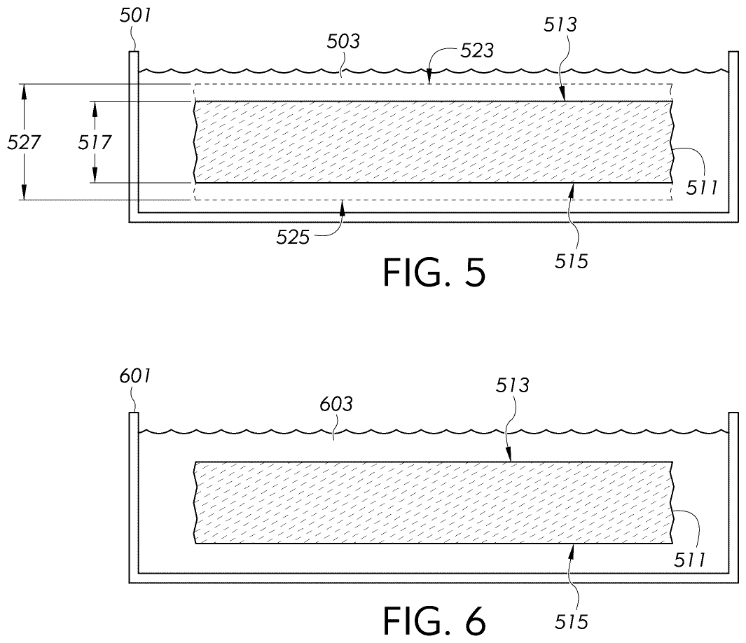

Aspects of methods of making the glass-based substrate 101 illustrated in FIGS. 1-2, in accordance with aspects of the disclosure, will be discussed with reference to the example method steps illustrated in FIGS. 5-6. While methods discussed below use a treatment solution after etching the substrate to form the depletion layer, it is to be understood that the depletion layer can be formed by other methods. For example, a chemistry of an etching used for the etching can be modified to form a depletion layer within the scope of the present disclosure (with or without subsequent use of the treatment solution. Also, a different treatment solution can be used. Alternatively, additional steps can be used to develop a depletion layer subsequent to the etching and/or using the treatment solution. Without wishing to be bound by theory, it is believed that the composition of the glass-based substrate, a composition (e.g., presence of components and/or concentrations of components) in an etching solution (for etching the initial glass-based substrate) and/or a treatment solution as well as the order of treatment steps and any additional treatments can alter (e.g., increase, decrease, not form, from) the status and/or properties of a resulting depletion layer (if any).

In a first step of methods of the disclosure, as shown in FIGS. 5-6, methods can start with providing an initial glass-based substrate 511. In aspects, the initial glass-based substrate 511 may be provided by purchase or otherwise obtaining a substrate or by forming the initial glass-based substrate. In aspects, the initial glass-based substrate 511 can comprise a glass-based material. In further aspects, a composition of the initial glass-based substrate 511 can be within one or more of the ranges discussed above for the composition of the glass-based substrate. In further aspects, initial glass-based substrate can be provided by forming them with a variety of ribbon forming processes, for example, slot draw, down-draw, fusion down-draw, up-draw, press roll, redraw, or float. In further aspects, glass-based substrates comprising ceramic crystals can be provided by heating a glass-based substrate to crystallize one or more ceramic crystals. The initial glass-based substrate 511 may comprise an initial first major surface 523 and an initial second major surface 525 opposite the initial first major surface 523. In further aspects, an initial thickness 527 of the initial glass-based substrate 511 (defined as an average distance between the initial first major surface 523 and the initial second major surface 525) can be within one or more of the ranges discussed above and/or may be within 5 μm of the final thickness (e.g., substrate thickness 109) (i.e., greater than the final thickness by from 0.1 μm to 5 μm or from 0.5 μm to 4 μm). Alternatively, in further aspects, an initial thickness 527 of the initial glass-based substrate 511 (defined as an average distance between the initial first major surface 523 and the initial second major surface 525) can be greater than the resulting final thickness (e.g., substrate thickness 109) by 5 μm or more, 10 μm or more, 15 μm or more, 20 μm or more, 25 μm or more, 30 μm or more, 40 μm or more, or 50 μm or more (e.g., from 5 μm to 250 μm, from 10 μm to 200 μm, from 15 μm to 150 μm, from 20 μm to 100 μm, from 25 μm to 75 μm, from 30 μm to 50 μm, or any range or subrange therebetween). In further aspects, the initial first major surface 523 and/or the initial second major surface 525 can extend along a plane. In aspects, the initial glass-based substrate 511 can have a composition within one or more of the ranges discussed above for the glass-based substrate 101. In aspects, initial glass-based substrate 511 and/or the resulting glass-based substrate 101 can be substantially unstrengthened.

Methods can comprise etching the initial glass-based substrate 511 to reduce a thickness (e.g., initial thickness 527) of the initial glass-based substrate 511 to form at least an intermediate first major surface 513 and the intermediate thickness 517, as shown in FIG. 5. In aspects, as shown, etching the initial glass-based substrate 511 can comprise contacting the initial first major surface 523 and/or the initial second major surface 525 with an etchant 503 to form the intermediate first major surface 513 and/or the intermediate second major surface 515. In further aspects, as shown, the etching (e.g., contact with the etchant 503) can remove material of the initial glass-based substrate 511 from the initial first major surface 523 and/or the initial second major surface 525 can reduce the initial thickness 527 to the intermediate thickness 517. In even further aspects, the intermediate thickness 517 can be within 5 μm of (e.g., from 0 μm to 5 μm greater than) the substrate thickness 109 of the resulting glass-based substrate 101. For example, a thickness removed from the initial glass-based substrate by etching with the etchant can be within one or more of the thickness ranges discussed in the previous paragraph. In further aspects, as shown in FIG. 5, etching the initial glass-based substrate 511 can comprise immersing the initial glass-based substrate 511 in the etchant 503 that is contained in an etchant bath 501. Alternatively, etching the initial glass-based substrate 511 can comprise spraying the etchant 503 on the initial glass-based substrate 511, for example, in a vertical top spray etching process including the method described in WO2023/278223A1, which is incorporated by reference herein in its entirety.

In aspects, the etchant 503 can comprise hydrofluoric acid (HF). In further aspects, the etchant can additionally include one or more mineral acids (e.g., nitric acid, hydrochloric acid, phosphoric acid, and/or sulfuric acid) in addition to HF. Also, it is to be understood that a buffered HF solution (including NH₄F and/or NH₄HF) can form a different surface composition than using pure HF and that both surface compositions can be different from that of using HF with a mineral acid. Also, a temperature of the etchant, a concentration of the component(s) in the etchant, and an etching time can influence the thickness and/or surface composition of the resulting glass-based substrate.

In aspects, the etchant 503 can comprise HF, as a wt % of the etchant, in an amount of 0.5 wt % or more, 0.55 wt % or more, 0.6 wt % or more, 1.5 wt % or less, 1.25 wt % or less, 1.0 wt % or less, 0.75 wt % wt % or less, 0.7 wt % or less, or 0.65 wt % or less. In aspects, the etchant 503 can comprise HF, as a wt % of the etchant, in an amount in a range from 0.5 wt % to 1.5 wt %, from 0.5 wt % to 1.25 wt %, from 0.5 wt % to 1.0 wt %, from 0.5 wt % to 0.75 wt %, from 0.55 wt % to 0.70 wt %, from 0.6 wt % to 0.65 wt %, or any range or subrange therebetween. In aspects, the etchant 503 can comprise one or more mineral acid(s), as a wt % of the etchant, of 0.75 wt % or more, 0.8 wt % or more, 0.85 wt % or more, 0.9 wt % or more, 0.95 wt % or more, 1.0 wt % or more, 1.1 wt % or more, 5.0 wt % or less, 4.0 wt % or less, 3.0 wt % or less, 2.5 wt % or less, 2.0 wt % or less, 1.75 wt % or less, 1.5 wt % or less, 1.25 wt % or less, or 1.0 wt % or less. In aspects, the etchant 503 can comprise one or more mineral acid(s), as a wt % of the etchant, in a range from 0.75 wt % to 5.0 wt %, from 0.8 wt % to 4.0 wt %, from 0.8 wt % to 3.0 wt %, from 0.85 wt % to 2.5 wt %, from 0.9 wt % to 2.0 wt %, from 0.95 wt % to 1.75 wt %, from 1.0 wt % to 1.5 wt %, from 1.0 wt % to 1.25 wt %, or any range or subrange therebetween.

Throughout the disclosure, a pH of a solution is measured in accordance with ASTM E70-90 at 25° C. In aspects, a pH of the etchant 503 can be 2.0 or more, 2.3 or more, 2.5 or more, 2.7 or more, 3.0 or more, 3.3 or more, 3.5 or more, 3.6 or more, 3.7 or more, 3.8 or more, 4.5 or less, 4.3 or less, 4.0 or less, 3.9 or less, 3.8 or less, 3.7 or less, 3.6 or less, 3.5 or less, 3.3 or less, 3.0 or less, 2.7 or less, or 2.5 or less. In aspects, a pH of the etchant 503 can be in a range from 2.0 to 4.5, from 2.3 to 4.3, from 2.5 to 4.0, from 2.7 to 3.9, from 3.0 to 3.8, from 3.3 to 3.5 to 3.6 or any range or subrange therebetween. Providing a relatively high pH (e.g., from 3.3 to 4.5) can decrease an etching rate that can help produce a relatively uniform thickness of the glass-based substrate and/or change a surface composition of the glass-based substrate relative to using etchants with other pHs.

In aspects, an etch rate of a thickness of the initial glass-based substrate during the etching can be 0.5 micrometers per minute (μm/min) or more, 1 μm/min or more, 1.5 μm/min or more, 3.5 μm/min or less, 3 μm/min or less, 2.5 μm/min or less, or 2 μm/min or less. In aspects, an etch rate of a thickness of the initial glass-based substrate during the etching can be from 0.5 μm/min to 3.5 μm/min, from 0.5 μm/min to 3 μm/min, from 1 μm/min to 3 μm/min, from 1 μm/min to 2.5 μm/min, from 1.5 μm/min to 2.5 μm/min, from 1.5 μm/min to 2 μm/min, from 1 μm/min to 2 μm/min, or any range or subrange therebetween. Based on the etch rate, the initial thickness, and the intended final thickness, an appropriate etching time can be selected. Providing a sufficiently low etch rate (e.g., 3 μm/min or less, 2.5 μm/min or less, 2 μm/min or less) can increase a yield of sheets relative to a higher etch rate because an incidence of defects can be reduced. Providing a sufficiently high etch rate (e.g., 0.5 μm/min or more, 1 μm or more) can increase a throughput of methods because glass-based sheet can be etched faster than if a lower etch rate was used without a significant increase in defects. In aspects, a temperature of the etchant 503 can be 20° C. or more, 22° C. or more, 25° C. or more 28° C. or more, 30° C. or more, 40° C. or less, 35° C. or less, 30° C. or less, 28° C. or less, 25° C. or less, or 23° C. or less. In aspects, a temperature of the etchant 503 can range from 20° C. to 40° C., from 20° C. to 35° C., from 20° C. to 30° C., from 20° C. to 28° C., from 20° C. to 25° C., from 22° C. to 23° C., or any range or subrange therebetween.

In aspects, as shown in FIG. 6, methods can proceed to contacting at least the intermediate first major surface 513 with a treatment solution 603 to form the first major surface 105 and the glass-based substrate 101 (see FIG. 1). In further aspects, as shown, the intermediate second major surface 515 can also be contacted with the treatment solution 603. In further aspects, as shown, the glass-based substrate (e.g., initial glass-based substrate 511) can be immersed in the treatment solution 603 that is contained in a treatment bath 601. In further aspects, the treatment solution 603 can remove (e.g., dissolve and/or displace) any residual material from the etchant from the glass-based substrate. In aspects, the treatment solution 603 can be agitated (e.g., ultrasonicated) to further facilitate treatment (e.g., rinsing) of the surfaces of the glass-based substrate. In further aspects, the treatment solution 603 can comprise and/or be water (e.g., purified, filtered, deionized, and/or distilled), an alkaline detergent solution, or combinations thereof. It is to be understood that a series of treatment solutions can be used, where the composition of the series of treatment solutions can be the same, can alternate, or change step-wise (e.g., a concentration increasing in each successive treatment solution of the series of treatment solutions).

As used herein, a pH of the treatment solution is measured in accordance with ASTM E70-90 at 25° C. with standard solutions extending to a pH of at least 14. In even further aspects, the alkaline detergent solution (e.g., treatment solution 603) can comprise an alkaline detergent and a pH of 12 or more, 12.3 or more, 12.5 or more, 12.6 or more, 12.7 or more, 12.8 or more, 12.9 or more, 13.0 or more, 13.5 or less, 13.4 or less, 13.3 or less, 13.2 or less, 13.1 or less, 13.0 or less, 12.9 or less, 12.8 or less, 12.7 or less, or 12.6 or less. In aspects, the alkaline detergent solution (e.g., treatment solution 603) can comprise a pH ranging from greater than or equal to 12.5 to less than or equal to 13.5, from greater than or equal to 12.6 to less than or equal to 13.4, from greater than or equal to 12.7 to less than or equal to 13.3, from greater than or equal to 12.8 to less than or equal to 13.2, from greater than or equal to 12.9 to less than or equal to 13.1, or any range or subrange therebetween. In aspects, a pH of the alkaline detergent solution (e.g., treatment solution 603) can be at least 13.0, for example, in a range from greater than or equal to 13.0 to less than or equal to 13.5, from greater than or equal to 13.1 to less than or equal to 13.4, from greater than or equal to 13.2 to less than or equal to 13.3, or any range or subrange therebetween. In aspects, a pH of the alkaline detergent solution (e.g., treatment solution 603) can be less than or equal to 13.0, for example, in a range from greater than or equal to 12.5 to less than or equal to 13.0, from greater than or equal to 12.6 to less than or equal to 12.9, from greater than or equal to 12.7 to less than or equal to 12.8, or any range or subrange therebetween.

In aspects, the alkaline detergent solution (e.g., treatment solution 603) can comprise an alkaline detergent in a concentration of 0.1 wt % or more, 0.2 wt % or more, 0.3 wt % or more, 0.4 wt % or more, 0.5 wt % or more, 0.7 wt % or more, 1 wt % or more, 1.5 wt % or more, 2 wt % or more, 6 wt % or less, 5 wt % or less, 4 wt % or less, 3 wt % or less, 2.5 wt % or less, 2.0 wt % or less, 1.5 wt % or less, 1.2 wt % or less, 1.0 wt % or less, 0.9 wt % or less, 0.8 wt % or less, 0.7 wt % or less, or 0.6 wt % or less. In aspects, the alkaline detergent solution (e.g., treatment solution 603) can comprise an alkaline detergent in a concentration in a range from greater than or equal to 0.1 wt % to less than or equal to 6.0 wt %, from greater than or equal to 0.2 wt % to less than or equal to 5 wt %, from greater than or equal to 0.3 to less than or equal to 4 wt %, from greater than or equal to 0.4 wt % to less than or equal to 3 wt %, from greater than or equal to 0.5 wt % to less than or equal to 2.5 wt %, from greater than or equal to 0.6 wt % to less than or equal to 2 wt %, from greater than or equal to 0.7 wt % to less than or equal 1.5 wt %, from greater than or equal to 0.8 wt % to less than or equal 1.2 wt %, from greater than or equal to 0.9 wt % to less than or equal 1.0 wt %, or any range or subrange therebetween. In aspects, the alkaline detergent solution (e.g., treatment solution 603) can comprise an alkaline detergent in a concentration of 1.0 wt % or less, for example, in a range from greater than or equal to 0.5 wt % to less than or equal to 1.0 wt %, from greater than or equal to 0.6 wt % to less than or equal to 0.9 wt %, from greater than or equal to 0.7 wt % to less than or equal to 0.8 wt %, or any range or subrange therebetween. An exemplary aspect of an alkaline detergent solution includes SemiClean KG (Yokohama Oils & Fats Industry Co.). It is unexpected that a dilute treatment solution (e.g., alkaline detergent in a concentration of 1.0 wt % or less, 0.9 wt % or less, 0.8 wt % or less, 0.7 wt % or less, etc.) can be used to form a depletion layer (e.g., providing improved micro-scratch resistance as discussed herein).

In aspects, the treatment solution 603 can comprise a treatment temperature and/or be in contact with the glass-based substrate (e.g., initial glass-based substrate 511) for a treatment period of time. In further aspects, sonication can be applied for at least half of the rinsing period of time, for example, the entire first period of time. In further aspects, the treatment period of time can be 2 minutes or more, 3 minutes or more, 4 minutes or more, 5 minutes or more, 7 minutes or more, 10 minutes or more, 15 minutes or more, 20 minutes or more, 25 minutes or more, 30 minutes or more, 60 minutes or less, 45 minutes or less, 35 minutes or less, 30 minutes or less, 25 minutes or less, 20 minutes or less, 15 minutes or less, 10 minutes or less, 8 minutes or less, or 6 minutes or less. In aspects, the treatment period of time can range from 2 minutes to 60 minutes, from 3 minutes to 45 minutes, from 4 minutes to 35 minutes, from 5 minutes to 30 minutes, from 7 minutes to 25 minutes, from 10 minutes to 20 minutes, or any range or subrange therebetween. In aspects, the treatment temperature can be 20° C. or more, 25° C. or more, 30° C. or more, 35° C. or more, 65° C. or less, 60° C. or less, 55° C. or less, or 45° C. or less. In aspects, the first temperature can range from 20° C. to 65° C., from 25° C. to 60° C., from 30° C. to 55° C., from 35° C. to 45° C., or any range or subrange therebetween. Also, without wishing to be bound by theory, the alkaline detergent solution may selectively act on surface flaws (e.g., removing, rounding, blunting) before removing material from other parts of the surface, which can increase the impact resistance of the substrate without removing a substantial thickness from the surface of the glass-based substrate.

The combination of the etching and contacting with the treatment solution can form the depletion layer having one or more of the aspects described above. In aspects, methods can proceed to assembling a consumer electronic product from the glass-based substrate. Methods can be complete after contacting the intermediate first major surface 513 with the treatment solution 603 and/or after assembling the consumer electronic product using the glass-based substrate. Any of the above options may be combined to make a glass-based substrate in accordance with aspects of the disclosure.

In aspects, methods in accordance with aspects of the disclosure may consist of the steps discussed above. For example, the glass-based substrate may not be further treated between one or more (or even all of) the steps described above. Throughout the disclosure, the phrase “not further treated” or “not be further treated” excludes treatments to the first major surface other than the stated contacting with a solution and rinsing with water (e.g., purified, filtered, deionized, distilled). Exemplary aspects of treatments that can be excluded under “not further treated” or “not be further treated” include treatment with additional etchants (e.g., acidic solutions, fluorine-containing solutions), treatment solutions (e.g., alkaline solutions, detergents), and mechanical polishing of the glass-based substrate.

### Examples

Various aspects will be further clarified by the following examples. Examples 1-6 comprised were formed from initial glass-based substrates with an initial thickness of 70 μm and bulk composition A (65.1 mol % SiO₂, 14.0 mol % Al₂O₃, 16.4 mol % Na₂O, 3.4 mol % MgO, 1.0 mol % CaO, 0.1 mol % SnO₂). Examples 1-6 were etched using an HF and nitric acid basis etchant to achieve samples with thicknesses of 56 μm and 37 μm with samples of both thicknesses processed in accordance with the following conditions. Examples 1-2 were etched at a rate of about 0.5 μm/min while Examples 3-6 were etched at a rate of about 0.9 μm/min. The etchant composition for Example 1-2 was different than the etchant composition for Examples 3-6. Unless otherwise indicated (Examples 1-2 being the exception), the results reported in this section refer to the 56 μm sample with the understanding that the 37 μm sample had similar results (overlapping standard error ranges).

Example 1 comprised a thickness of 37 μm while Example 2 had a thickness of 56 μm). After etching, Examples 1-2 and 6 were rinsed in deionized water at 30° C. for 20 minutes (no alkaline detergent). Examples 3-5 were rinsed in deionized followed by a treatment solution maintained at 30° C. for about 6 minutes and then again rinsed in deionized water. In Example 5, the treatment solution was a 0.25 wt % alkaline detergent solution having a pH of 12.3. In Example 3, the treatment solution was a 0.5 wt % alkaline detergent solution having a pH of 12.6. In Example 4, the treatment solution was a 5 wt % alkaline detergent solution having a pH of 13.5.

Table 1 presents the properties of Examples 1-6. FIGS. 7 and 8A-8B schematically present TEM images of the glass-based substrates of Examples 1, 4, and 6, respectively. As shown, the depletion region 703, 803, and 803 (if present) is positioned between the first major surface 705, 805, and 815 of the glass-based substrate and the bulk 701, 801, and 811 of the glass-based substrate. A maximum depth that the depletion region extends from the first major surface 705, 805, and 815 is shown to a dashed line 707 and 807 corresponding to an average location of the interface between the depletion region 703, 803, and 813 and the bulk 701, 801, and 811. As shown in FIG. 8B, the maximum depth of Example 8B is 75.93 nm, and the average depletion depth reported in Table 1 is about 75 nm (73±2 nm). As shown in FIG. 8A, the maximum depth of Example 4 is 2.50 nm, but the average depletion depth reported in Table 1 rounds down to 0 nm. This indicates that the high concentration of the detergent solution in Example 4 removes essentially any depletion layer that was formed during the processing (e.g., compare Example 4 to Example 6). It is believed a slightly acidic pH deionized water rinse may have generated the negligible depletion layer (see FIG. 8A); however, it is believed that this pH could not develop a deeper depletion layer. As shown in FIG. 7, the maximum depth of Example 1 is 11.45 nm, and the average depth reported in Table 1 is slightly more than 10 nm (11±1 nm). As show in Table 1, Examples 1-3 and 5 have an average thickness of the depletion layer from 5 nm to 50 nm with an average thickness of the depletion layer in Example 3 is less than 12 nm (and less than 10 nm, but from 5 nm to 12 nm and from 5 nm to 10 nm) and an average thickness of the depletion layer in Example 5 is greater than 10 nm and about 12 nm or more (e.g., from 10 nm to 50 nm, from 12 nm to 25 nm).

TABLE 1
Properties of Examples 1-6

| | Condition | | | | |
|---|---|---|---|---|---|
| | Depletion | IR peak for | Difference | Scratch | Kinetic |
| | thickness | depletion | in IR peak | Depth (nm) | Coefficient |
| Example | (nm) | layer (cm⁻¹) | (cm⁻¹) | (1 mN load) | of Friction |
| 1 (37 μm) | 11 ± 1 | 1025.1 ± 0.6 | 4.8 | 18 ± 3 | 0.043 ± 0.015 |
| 2 (56 μm) | 9 ± 1 | 1025.6 ± 0.1 | 4.3 | 20.0 ± 4 | 0.041 ± 0.011 |
| 3 (0.5 wt %) | 8 ± 1 | 1028.9 ± 0.1 | 0.5 | 19.6 ± 1.4 | 0.041 ± 0.016 |
| 4 (5 wt %) | 0 ± 1 | 1029.4 ± 0.2 | 0 | 21 ± 10 | 0.051 ± 0.017 |
| 5 (0.3 wt %) | 12 ± 1 | 1028.4 ± 0.1 | 0.9 | 18 ± 2 | 0.071 ± 0.018 |
| 6 (0 wt %) | 73 ± 2 | 1008.1 ± 1.2 | 21.3 | 34 ± 6 | 0.087 ± 0.021 |

Table 1 also presents the location of the peak in the IR spectrum (in the range from 1000 cm⁻¹ to 1070 cm⁻¹) for the depletion layer as well as a difference between a peak in the IR spectrum for the bulk minus the peak in the IR spectrum for the depletion layer (i.e., bulk minus depletion layer). For the composition used here, the peak in the IR spectrum for the bulk was at 1029.4 cm⁻¹. As shown in Table 1, Example 6 (with the thickest depletion layer) had the greatest difference in the location of IR peaks (21.3 cm⁻¹) that was greater than 10 cm⁻¹. At the other extreme, Example 4 (with essentially no depletion layer) had no discernable difference in the peak location relative to bulk (0 cm⁻¹). Examples 1-3 and 5 have differences in the IR peak between these extremes, for example, from 0.4 cm⁻¹ to 5 cm⁻¹. Examples 3 and 5 have differences in the location of the peak for the depletion layer relative to the bulk of about 1 cm⁻¹ or less (e.g., from 0.4 cm⁻¹ to 1 cm⁻¹, from 0.5 cm⁻¹ to 0.9 cm⁻¹).

Table 1 and FIG. 12 present the scratch depth (SD) for a 1 mN load performed and measured as described above. FIG. 12 presents the full range of samples measured for each Example with the scratch depth in nm on the vertical axis 1201 (e.g., y-axis), where the dashed line is the mean value and the error bars are shown. As shown, Example 6 (with the thickest depletion layer) has a scratch depth greater than 30 nm (e.g., 34±6 nm). Also, the scratches in Example 6 were clearly visible to the naked eye, which indicates that a depletion layer of about 75 nm or more may complicate quality control and/or have negative aesthetic characteristics. Also, Example 4 (without a significant depletion layer) has a scratch depth greater than 20 nm (21±10 nm). As discussed above, it is believed that when the scratch depth from the 1 mN load greatly exceeds the depletion layer thickness, the glass-based substrate is susceptible to noticeable surface damage that can occur incidentally as glass-based substrates are transported, packaged, or otherwise handled. In contrast, Examples 1-3 and 5 have scratch depths comparable to (albeit slightly less for Example 1-2 relative to) that of Example 4, but since the depletion layer is greater than in Example 4, these scratches were less visible (and the depletion layer thickness was within about a factor or 2 of the scratch depth).

Although not shown in Table 1, Examples 1 and 4 were also tested with a 0.5 mN load. For the 0.5 mN load, Example 1 had a scratch depth of 9±2 nm, and Example 4 had a scratch depth of 17±3 nm. The scratch depth for Example 1 was much less (about a factor of 2 less) than that for Example 4. Also, relative to the scratch depth for a 1 mN load, the scratch depth with the 0.5 mN load decreased more for Example 1 than for Example 4. This demonstrates that glass-based substrates with reasonable depletion layers (e.g., from 3 nm to 50 nm, from 5 nm to 30 nm) have increased scratch resistance to small loads, especially when the scratch can be contained within the depletion layer-perhaps accounting for the large decrease in scratch depth for Example 1 relative to Example 4 going from a load of 1 mN to 0.5 mN. It is expected that Examples 2-3 and 4 would exhibit similarly large decreases in scratch depth for a load of 0.5 mN (relative to the 1 mN load). Also, the surface roughness Ra was measured for Examples 1 and 4. Example 1 had a surface roughness Ra of 0.67 nm, and Example 4 had a surface roughness Ra of 0.68 nm. This indicates that the presence of the depletion layer in Example 1 does not significantly change the surface roughness (at least Ra) relative to glass-based substrates without a depletion layer (Example 4).

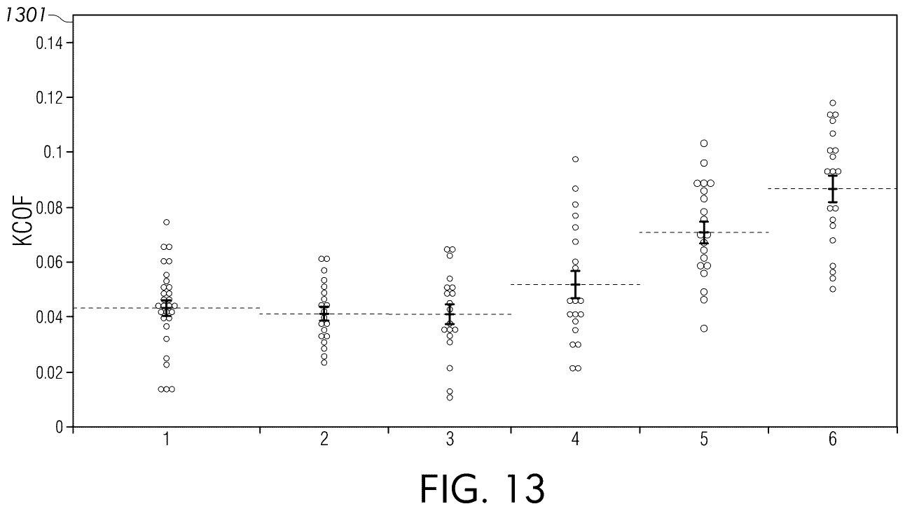

Table 1 and FIG. 13 present the kinetic coefficient of friction (KCOF) for Examples 1-6. FIG. 13 presents the full range of samples measured for each Example with the kinetic coefficient of friction (unitless) on the vertical axis 1301 (e.g., y-axis), where the dashed line is the mean value and the error bars are shown. As shown, Example 6 (with the thickest depletion layer) has a KCOF of more than 0.08 (0.087±0.021). Example 4 (without a significant depletion layer) has a KCOF of about 0.05 (0.051±0.017). Examples 1-3 have a KCOF less of about 0.04, which is less than that of Example 4. Example 5 has a KCOF of about 0.07 (0.071±0.018) that is in between that for Example 4 and Example 6.

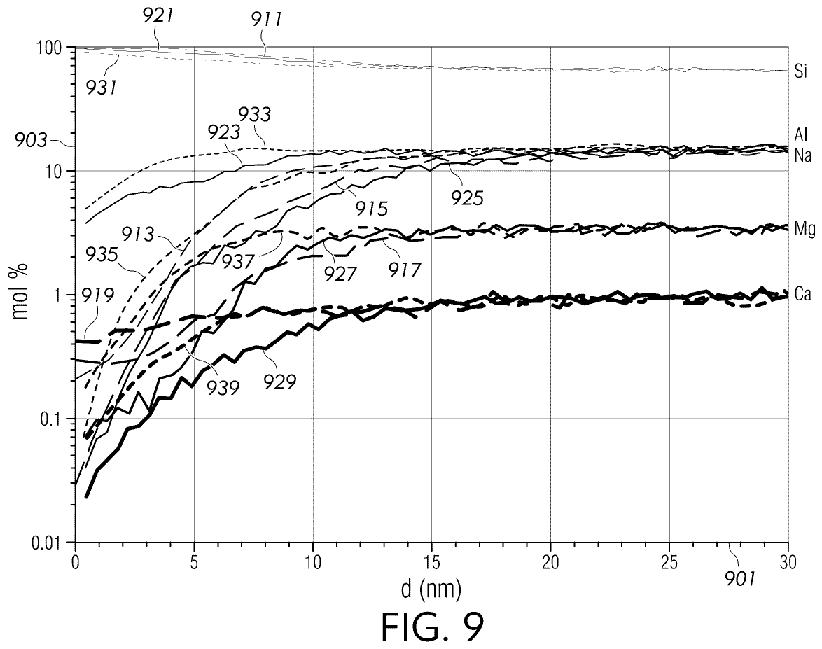

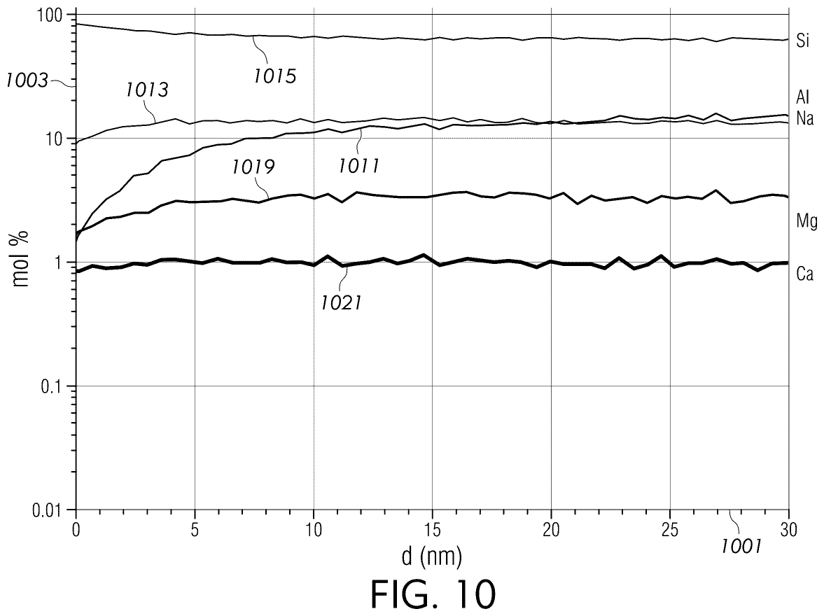

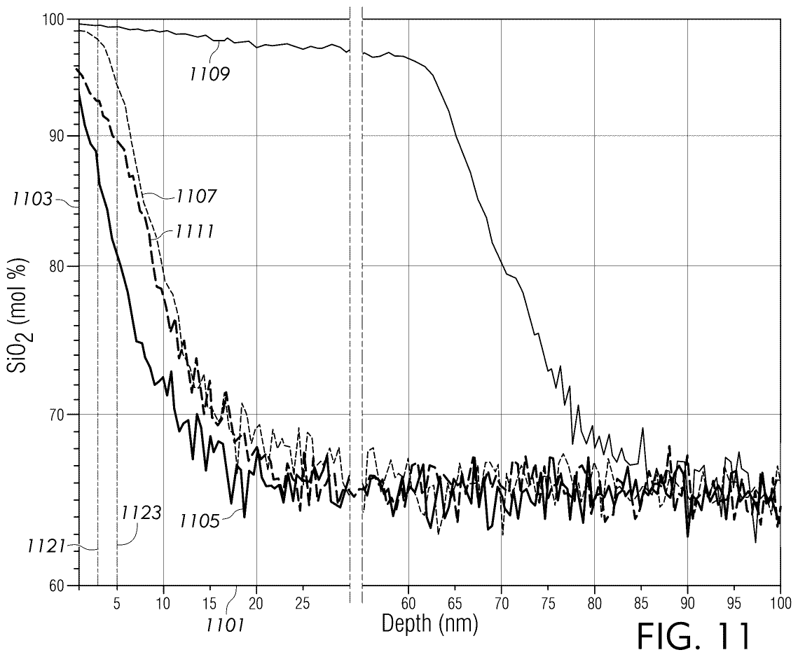

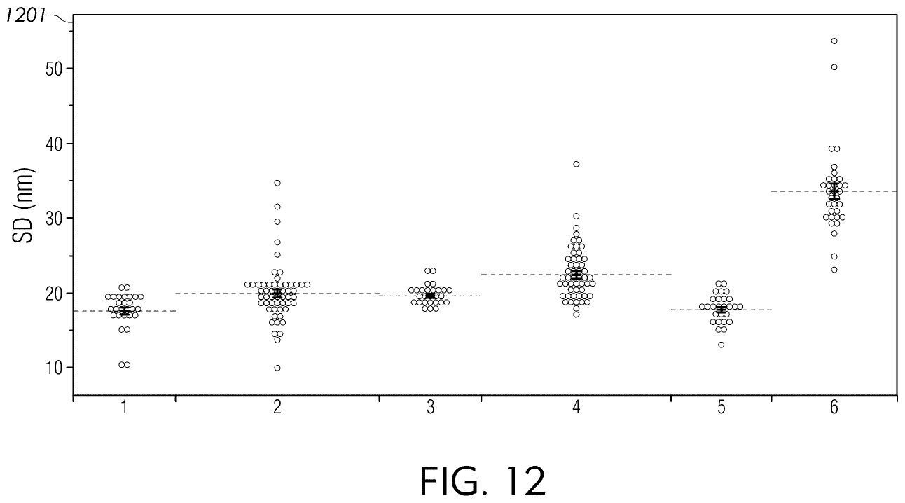

FIGS. 9-11 present concentration profiles as measured by SIMS, where the horizontal axis 901, 1001, and 1101 (e.g., x-axis) corresponds to distance (d) from the first major surface in nm and the vertical axis 903, 1003, and 1103 corresponds to concentration in mol % (at the corresponding distance from the first major surface). FIGS. 9-10 have a logarithmically scaled vertical axis (e.g., y-axis) to better show differences in small concentrations while FIG. 11 has a linearly scaled vertical axis (e.g., y-axis) to better show differences in the relatively high concentrations of SiO₂ near the surface.

FIG. 10 schematically illustrates concentration profiles of components in Example 4, which has substantially no depletion layer. Curve 1011 corresponds to Na₂O concentration, curve 1013 corresponds to Al₂O₃ concentration, curve 1015 corresponds to SiO₂ concentration, curve 1019 corresponds to MgO concentration, and curve 1021 corresponds to CaO concentration. Curve 1011 (Na₂O) decreases the most towards the surface, but still remains above 1 mol % at the first major surface (and greater than 25% of the bulk concentration at a depth of 3 nm, 5 nm, and 7 nm). Curves 1013, 1019, and 1021 (Al₂O₃, MgO, and CaO, respectively) exhibit little to no decrease (generally within natural fluctuations other than the first 1 nm from the first major surface). Consequently, the Al₂O₃ concentration (curve 1013) stays within 25% of its value in bulk for the entire thickness range plotted. Likewise, the MgO (curve 1019) and CaO (curve 1021) concentrations stay within about 25% of the corresponding concentration in bulk for the entire thickness range plotted (and certainty at distances of 3 nm, 5 nm, and 7 nm from the first major surface). While curve 1015 (SiO₂ concentration) slightly increases towards the first major surface, it is still below about 80% for the entire thickness range. The relatively stable concentrations of Al₂O₃, MgO, CaO, and SiO₂ are consistent with substantially no depletion layer noted in Table 1 and FIG. 7.

FIG. 9 schematically illustrates concentration in mol % on the vertical axis 903 (e.g., y-axis) as a function of depth (d) from the first major surface in nanometers on the horizontal axis 901 (e.g., x-axis) for various oxides for Examples 1, 3, and 5. Curves 911, 913, 915, 917, and 919 correspond to Example 1, curves 921, 923, 925, 927, and 929 correspond to Example 3, and curves 931, 933, 935, 937, and 939 correspond to Example 5. Curves 911, 921, and 931 correspond to SiO₂ concentration, which increases towards the first major surface (discussed in further detail with reference to FIG. 11 below) as the other elements are depleted in the depletion layer. Curves 913, 923, and 933 correspond to Al₂O₃ concentration, which dips below 10 mol % within 1 nm of the surface. Curve 913 (Example 1) decrease more drastically than curves 923 and 923 for distances less than about 7 nm from the first major surface. Compared to curve 1013 in FIG. 10, curves 913, 923, and 933 all show marked decreases within 3 nm, 5 nm, and 7 nm of the first major surface. Curves 915, 925 and 935 correspond to Na₂O concentration, which all drop from greater than 10 mol % in the bulk to less than about 0.1 mol % at the first major surface (compare to greater than 1 mol % at the surface for curve 1011 in FIG. 10). Also, 915, 925 and 935 all drop to less than 25% of the bulk concentration at distances of 3 nm, 5 nm, and 7 nm from the first major surface. Curves 917, 927 and 937 correspond to MgO concentration, which all drop from greater than 1 mol % in the bulk to about 0.2 mol % or less at the first major surface. In contrast, curve 1019 in FIG. 10 stayed about 1 mol % for the entire thickness. Also, curves 917, 927 and 937 have less than 25% of the bulk concentration at a distance of 3 nm from the first major surface. Curves 919, 929 and 939 correspond to CaO concentration. Curves 929 and 939 drop to less than 0.2 mol % at a distance of 3 nm (less than 50% of the bulk value) and less than 0.1 mol % closer to the first major surface. In contrast, curve 1021 of FIG. 10 stayed relatively constant for the entire range plotted. Taken together, the presence of the depletion zone can be further confirmed (in addition to the TEM images in FIGS. 8A-8B) and characterized by the SIMS depth profiles that show decrease in alumina, alkali metal oxides (e.g., Na₂O), and alkaline earth metal oxides (e.g., MgO and CaO) within the depletion layer.

FIG. 11 schematically illustrates concentration in mol % of SiO₂ on the vertical axis 1103 (e.g., y-axis) as a function of depth (d) from the first major surface in nanometers on the horizontal axis 1101 (e.g., x-axis) for Examples 1, 3, 5, and 6. In FIG. 11, axis 1121 corresponds to a depth of 3 nm from the first major surface, and axis 1123 corresponds to a depth of 5 nm from the first major surface. Curve 1107 corresponds to Example 1, curve 1105 corresponds to Example 3, curve 1111 corresponds to Example 5, and curve 1109 corresponds to Example 6. As shown, the SiO₂ concentration increases by at least 10 mol % in the depletion layer relative to the bulk (e.g., compare a concentration at a distance of 3 nm, 5 nm, or even 7 nm to the bulk concentration). As shown, curve 1109 (Example 6) has greater than 90 mol % SiO₂ extending to at least 60 nm from the first major surface, while Examples 1, 3, and 5 are below 90 mol % by 5 nm from the first major surface (or further from the first major surface). At 3 nm from the surface, curve 1109 is greater than 95 mol % (about 99 mol % or more) while curves 1105, 1107, and 1111 are less than 95 mol % (and curve 1105 is less than 90 mol %). This is consistent with the much greater depletion layer thickness for Example 6 relative to the others. Curves 1107 and 1111 (Examples 1 and 5) have maximum SiO₂ concentrations greater than 90 mol % (e.g., 92 mol % or more, from 92 mol % to 95 mol %) at the first major surface whereas curve 1105 has a maximum concentration of SiO₂ less than 95 mol % (e.g., about 92%, even at the first major surface). At distances of 3 nm and 5 nm from the first major surface, curve 1107 (Example 1) has a SiO₂ concentration of greater than or equal to 90 mol % and 95 mol % whereas curves 1105 and 1111 (Examples 3 and 5) have SiO₂ concentrations less than 95 mol % (e.g., from 70 mol % to 95 mol %, from 80 mol % to 92 mol %, or from 85 mol % to 92 mol %).

The above observations can be combined to provide glass-based substrates and methods of making the same having a depletion layer extending from the first major surface. Providing a depletion layer can provide enhanced micro-scale scratch resistance to the glass-based substrate. As demonstrated by the Examples below, it appears that the depletion layer reduces the scratch depth for milliNewton scale loads (e.g., 0.5 mN, 1 mN) that can occur incidentally as glass-based substrates are transported, packaged, or otherwise handled during processing and/or shipping. When the scratch depth is less than or equal to the depth of depletion region (or even within a factor of 2), the scratch may be inhibited (e.g., prevented) from further growth (e.g., propagation) due to the different properties of the depletion layer relative to the bulk of the glass-based substrate. Additionally or alternatively, scratches within the depletion layer may not be visible to the naked eye, which can improve an aesthetic (e.g., cosmetic) appearance of the glass-based substrate relative to glass-based substrate experiencing the same loads (e.g., scratching conditions) without the presence of a depletion layer. However, depletion layers thicker than 75 nm can be visible to the naked eye when viewing an image through the glass-based substrate, which can impair a functionality of the glass-based substrate in display-related applications. Also, scratches in such thicker depletion layers (e.g., greater than 75 nm, 100 nm or more) can be visible (even when the scratch depth is within the depletion layer but deeper than about 30 nm or more (e.g., 50 nm or more), which can be impair an appearance of the glass-based substrate.

The depletion layer of the present disclosure can be formed by various methods. Examples 3 and 5 were produced using a dilute treatment solution following etching. It is unexpected that a dilute treatment solution (e.g., alkaline detergent in a concentration of 1.0 wt % or less, 0.9 wt % or less, 0.8 wt % or less, 0.7 wt % or less, etc.) following an etching treatment can be used to form a depletion region (e.g., providing improved micro-scratch resistance as discussed herein).

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error, and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

What is claimed is:

1. A glass-based substrate comprising:
a first major surface and a second major surface opposite the first major surface, a substrate thickness defined between the first major surface and the second major surface, and the substrate thickness is from 20 micrometers to 200 micrometers; and
a depletion layer extending from the first major surface to a first depth from the first major surface, the depletion layer is depleted in one or more alkali metal oxide, alkaline earth metal oxide, alumina, or combinations thereof relative to a bulk of the glass-based substrate, the depletion layer is enriched in silica relative to the bulk, and the first depth is from 1 nanometer to 75 nanometers.

2. The glass-based substrate of claim 1, wherein the depletion layer exhibits a first local peak in an infrared reflectance spectrum, the bulk exhibits a second local peak in an infrared reflectance spectrum, a location of the first local peak and a location of the second local peak are from 1000 cm⁻¹ to 1070 cm⁻¹, and a difference of the location of the second local peak minus the location of the first local peak is greater than or equal to 0.4 cm⁻¹.

3. The glass-based substrate of claim 2, wherein the difference of the location of the second local peak minus the location of the first local peak is from greater than or equal to 0.5 cm⁻¹ to less than or equal to 5.0 cm⁻¹.

4. The glass-based substrate of claim 3, wherein the difference of the location of the second local peak minus the location of the first local peak is from greater than or equal to 0.5 cm⁻¹ to less than or equal to 3.8 cm⁻¹.

5. The glass-based substrate of claim 1, wherein the depletion layer comprises greater than or equal to 10 mol % more silica than the bulk.

6. The glass-based substrate of claim 1, wherein the depletion layer comprises a maximum silica concentration from 80 mol % to 95 mol %.

7. The glass-based substrate of claim 1, wherein the first depth is from 5 nanometers to 50 nanometers.

8. The glass-based substrate of claim 7, wherein a concentration of silica at 3 nanometers from the first major surface is from 80 mol % to 95 mol %.

9. The glass-based substrate of claim 7, wherein a concentration of alumina at 3 nanometers from the first major surface is greater than or equal to 10 mol %.

10. The glass-based substrate of claim 7, wherein a concentration of alumina at 3 nanometers from the first major surface is less than or equal to 50% of a concentration of alumina in the bulk.

11. The glass-based substrate of claim 7, wherein a concentration of one or more alkali metal oxides at a 3 nanometers from the first major surface is less than or equal to 25% of a corresponding concentration of the one or more alkali metal oxides in the bulk.

12. The glass-based substrate of claim 7, wherein a concentration of one or more alkaline earth metal oxides at a 3 nanometers from the first major surface is less than or equal to 25% of a corresponding concentration of the one or more alkaline earth metal oxides in the bulk.

13. The glass-based substrate of claim 1, wherein a surface roughness Ra of the first major surface is from 0.3 nanometers to 1.0 nanometers.

14. The glass-based substrate of claim 1, wherein the first major surface exhibits a kinetic coefficient of friction from 0.01 to 0.12.

15. The glass-based substrate of claim 1, wherein the glass-based substrate exhibits a scratch depth of less than or equal to 20 nanometers for a nanoindentation of 1 milliNewton along a 1000 micrometer path.

16. The glass-based substrate of claim 1, wherein the glass-based substrate is substantially unstrengthened.

17. The glass-based substrate of claim 1, wherein the substrate thickness is from 30 micrometers to 80 micrometers.

18. The glass-based substrate of claim 1, wherein a composition of the bulk comprises:
from 40 mol % to 80 mol % SiO₂;
from 5 mol % to 30 mol % Al₂O₃;
from 0 mol % to 10 mol % B₂O₃;
from 0 mol % to 5 mol % ZrO₂;
from 0 mol % to 15 mol % P₂O₅;
from 0 mol % to 20 mol % R₂O, R₂O is a total amount of Li₂O, Na₂O, K₂O, Rb₂O, and Cs₂O; and
from 0 mol % to 15 mol % RO, RO is a total amount of MgO, CaO, SrO, BaO, and ZnO.
from 3 mol % to 7 mol % RO.

19. The glass-based substrate of claim 18, wherein the composition of the bulk comprises:
from 12 mol % to 18 mol % Na₂O;
from 0 mol % to 1 mol % Li₂O; and
from 0 mol % to 0.5 mol % K₂O, wherein the composition of the bulk exhibits Al₂O₃—Na₂O from greater than or equal to −6.0 mol % to less than or equal to −2 mol %.

20. A consumer electronic product comprising:
a housing comprising a front surface, a back surface, and a side surface;
electrical components at least partially within the housing, the electrical components comprising a controller, a memory, and a display, the display at or adjacent the front surface of the housing; and
a cover substrate disposed over the display,
wherein at least one of a portion of the housing comprises the glass-based substrate of claim 1.
